(19) United States
(12) Patent Application Publication
(10) Pub. No.: US 2013/0077285 A1
(43) Pub. Date: Mar. 28, 2013

(54) LAMP

(71) Applicants: Toshiaki Isogai, Osaka (JP); Yasuhisa Ueda, Osaka (JP); Kazushige Sugita, Hyogo (JP); Hideo Nagai, Osaka (JP); Takaari Uemoto, Osaka (JP); Masahiro Miki, Osaka (JP)

(72) Inventors: Toshiaki Isogai, Osaka (JP); Yasuhisa Ueda, Osaka (JP); Kazushige Sugita, Hyogo (JP); Hideo Nagai, Osaka (JP); Takaari Uemoto, Osaka (JP); Masahiro Miki, Osaka (JP)

(21) Appl. No.: 13/391,805

(22) PCT Filed: Sep. 27, 2011
(86) PCT No.: PCT/JP2011/005422

§ 371 Date: Feb. 22, 2012

(51) Int. Cl. F21V 13/02; F21V 8/00; F21V 9/00; F21V 7/05

(52) U.S. Cl. 362/84; 362/235

(57) ABSTRACT

A lamp pertaining to the present invention has an envelope including a base. The envelope houses semiconductor light-emitting elements, a circuit unit lighting the semiconductor light-emitting elements, and a light-guiding member. The light-guiding member has a hollow portion, and the circuit unit is housed in the hollow portion. The light-guiding member includes a light-receiving portion and a light-emitting portion connected to the light-receiving portion. The light-guiding member is held within the envelope such that the light-emitting portion faces the semiconductor light-emitting elements.

### TECHNICAL FIELD

The present invention relates to lamps utilizing semiconductor light-emitting elements such as LEDs (light-emitting diodes) as a light source, and particularly to a lamp having a base and a built-in circuit unit.

### BACKGROUND ART

Recently, owing to the practical use of high-intensity LEDs, lamps utilizing LEDs as a light source is becoming common. As an example, Patent Literature 1 discloses an LED lamp that substitutes a common incandescent light bulb. The LED lamp has a structure in which an LED module and a circuit unit are housed in an envelope. The LED module includes LEDs, and the circuit unit is used for lighting the LED module. The envelope includes a globe and a base. The circuit unit is arranged between the LED module and the base so as not to block the light emitted by the LED module.

### CITATION LIST

### Patent Literature

[Patent Literature 1] Japanese Patent Application Publication No. 2006-313717

[Patent Literature 2] Japanese Patent Application Publication No. 2005-286267

[Patent Literature 3] Japanese Patent Application Publication No. 2007-41467

### Non-Patent Literature

[Non-Patent Literature 1] “Comprehensive Lamp Catalog 2010” published by Panasonic Corporation Lighting Company, etc.

### SUMMARY OF INVENTION

### Technical Problem

The arrangement described above of the circuit unit, however, could reduce the lifetime of the circuit unit, because the circuit unit is located in the heat conduction path from the LED module to the base, and the electronic parts of the circuit unit could be broken by heat.

The present invention is made in view of the above problem, and aims to provide a lamp that is capable of preventing the possibility of a reduced lifetime due to heat generated by the circuit unit.

### Solution to Problem

A lamp pertaining to the present invention comprises: an envelope including a base; one or more semiconductor light-emitting elements; a circuit unit lighting the semiconductor light-emitting elements; and a light-guiding member having a hollow portion, a light-receiving portion, and a light-emitting portion connected to the light-receiving portion, the semiconductor light-emitting elements, the circuit unit and the light-guiding member are housed in the envelope, wherein the light-receiving portion is held within the envelope so as to face the semiconductor light-emitting elements, and at least part of the circuit unit is located within the hollow portion of the light-guiding member.

### Advantageous Effects of Invention

With the stated structure, at least part of the circuit unit is located within the hollow portion of the light guiding member whose light-emitting portion faces the semiconductor light-emitting elements. Hence, at least the part of the circuit unit located within the light-guiding member does not exist in the heat conduction path from the semiconductor light-emitting elements to the base. Therefore, the part of the circuit unit located within the light-guiding member is less affected by the temperature rise in the base and the members around the base caused by the heat generated by the semiconductor light-emitting elements during the operation. The electronic parts constituting the part are therefore not easily damaged by heat. Consequently, it is likely that the lifetime of the lamp can be extended.

As described above, the present invention provides a lamp that is capable of preventing the possibility of a reduced lifetime due to heat generated by the circuit unit.

### BRIEF DESCRIPTION OF DRAWINGS

FIG. 1 is a cross-sectional view schematically showing the structure of an LED lamp pertaining to Embodiment 1.

FIG. 2 is a perspective view showing a seating, an LED module, and a light-guiding member, which are included in the LED lamp shown in FIG. 1.

FIG. 3 is a cross-sectional view schematically showing the structure of an LED lamp pertaining to Embodiment 2.

FIGS. 4A-4D are cross-sectional views each schematically showing the structure of an LED lamp pertaining to a modification.

FIG. 5 is a cross-sectional view schematically showing the structure of an LED lamp pertaining to a modification.

FIGS. 6 is a cross-sectional view schematically showing the structure of an LED lamp pertaining to a modification.

FIGS. 7A and 7B shows components of the light-guiding member of the LED lamp shown in FIG. 6, and FIG. 7C shows a circuit substrate of the LED lamp.

FIG. 8 schematically shows the structure of an LED lamp pertaining to Embodiment 3.

FIG. 9 is a cross-sectional view schematically showing the structure of an LED lamp pertaining to Embodiment 4.

FIG. 10 is a perspective view showing a seating, an LED module, and a light-guiding member, which are included in the LED lamp shown in FIG. 9.

FIG. 11 is a cross-sectional view schematically showing the structure of an LED lamp pertaining to Embodiment 5.

FIG. 12 is a cross-sectional view schematically showing the structure of an LED lamp pertaining to Embodiment 6.

FIG. 13 is a cross-sectional view schematically showing the structure of an LED lamp pertaining to Embodiment 7.

FIG. 14 is a cross-sectional view schematically showing the structure of an LED lamp pertaining to Embodiment 8.

FIG. 15 is a cross-sectional view schematically showing the structure of an LED lamp pertaining to Embodiment 9.

FIG. 16 is an exploded perspective view of the light-guiding member, the LED module and the base.

FIG. 17 is a cross-sectional view schematically showing the structure of an LED lamp pertaining to Embodiment 10.

FIG. 18 is a cross-sectional view schematically showing the structure of an LED lamp pertaining to Embodiment 11.

FIG. 19 is a cross-sectional view schematically showing the structure of an LED lamp pertaining to Embodiment 12.

### DESCRIPTION OF EMBODIMENTS

### Embodiment 1

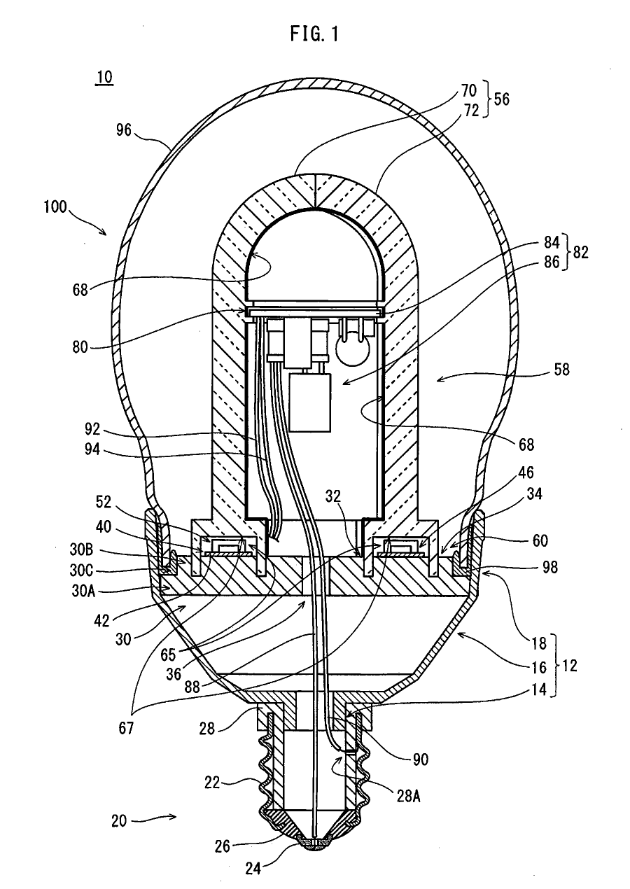

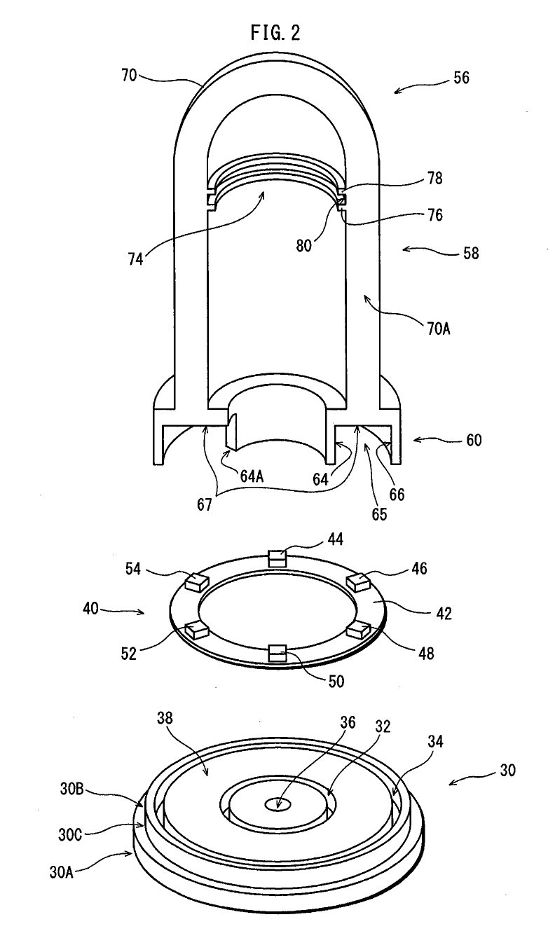

FIG. 1 is a cross-sectional view schematically showing the structure of a bulb-type LED lamp 10 pertaining to Embodiment 1. FIG. 2 is a perspective view showing a seating 30, an LED module 40 and a light-guiding member 56 (a first member 70), which are included in the LED lamp 10. Note that a circuit unit 82 in

FIG. 1 is not cut off Also note that the components shown in the drawings including FIG. 1 and FIG. 2 are not drawn to the same scale.

Materials, shapes and the likes used in the embodiments are merely examples, and the present invention is not limited to them. They may be changed within the scope of the technical concept of the present invention. Also, the embodiments may be combined together as long as they will not be contradictory when combined.

Although the following explains the case where LEDs are used as the semiconductor light-emitting elements, LDs (laser diodes) or organic light-emitting elements may be used instead.

### 1. Structure

### (1) Holder

As shown in FIG. 1, an LED lamp 10 has a holder 12 that is made of a metal material such as aluminum. Note that the holder 12 is not necessarily made of a metal material, and may be made of a heat conductive material having a preferable heat conducting property. The cross section of the holder 12 is substantially circular, and a small cylindrical part 14 and a large cylindrical part 18 are connected by a tapered tubular part 16.

### (2) Base

A base 20 is attached to the small cylindrical part 14 of the holder 12. The base 20 is in compliant with the E26 base standards defined in JIS (Japan Industrial Standards), for example. When used, the base 20 is fit to a socket (not depicted) for a common incandescent light bulb.

The base 20 has a shell 22, which is also referred to as a tubular body, and an eyelet 24, which has a circular dish shape. The shell 22 and the eyelet 24 are integrated in one piece with a first insulator 26 made of a glass material intervening therebetween. This integrated piece is fit in a second insulator 28 which has a cylindrical shape. The second insulator 28 is made of a heat-conducting insulating material, such as aluminum nitride (AlN). The second insulator 28 is provided with a through hole 28A from which a wiring line 90 extends outside.

As shown in FIG. 1, the small cylindrical part 14 of the base 20 is inserted in the second insulator 28, and the second insulator 28 is fixed to the small cylindrical part 14 by heatproof adhesive, which is not depicted.

### (3) Seating

A seating 30, which has a disk-like shape overall, is inserted in the large cylindrical part 18 of the holder 12. The seating 30 is made of a metal material such as aluminum.

The seating 30 includes a large-diameter part 30A and a small-diameter part 30B, and a step-like part 30C is formed. As shown in FIG. 2, an inner groove 32 and an outer groove 34 are formed concentrically on the face (surface) of the seating 30 that is farther from the base 20 than the other face. A through hole 36 is provided in the center point.

### (4) LED Module

On the surface of the seating 30, an LED module 40 is mounted on the area (hereinafter referred to as “the module mounting surface 38”) between the inner grove 32 and the outer groove 34.

As shown in FIG. 2, the LED module 40 has a wiring pattern for electrically connecting LEDs. The LED module 40 includes a mounting board 42, which is made from a printed wiring board having an annular shape, and a plurality of LEDs (six LEDs in this example), namely LEDs 44, 46, 48, 50, 52 and 54, which are mounted on the mounting board 42. On the mounting board 42, LEDs 44, . . . , 54 are mounted around the center point of the ring (every 60° in this example). That is, LEDs 44, . . . , 54 are arranged circularly (annularly in this example). Each of the LEDs 44, . . . , 54 is an LED that emits white light (white LED), which is composed of a blue LED chip and a yellow phosphor covering the chip. Here, the LEDs 44, . . . , 54 are electrically connected in series by the wiring pattern (not depicted) of the mounting board 42.

Note that the mounting board 42 is not necessarily perfectly-round, and may have any kind of annular shape, such as an oval annular shape. The number of LEDs 44, . . . , 54 is determined according to the amount of light required for the LED lamp 10.

### (5) Light-Guiding Member

The light-guiding member 56 is provided to stand on the surface of the seating 30. The light-guiding member 56 is made of acrylic resin, for example. Note that the light-guiding member 56 is not necessarily made of acrylic resin, and may be made of other translucent material. The light-guiding member 56 has a main body 58 and a leg 60.

The main body 58 has a cylindrical shape with a bottom. The leg 60 extends from the edges of the inner and outer circumferences of the annular opening of the main body 58, and includes an inner leg part 64 and an outer leg part 66, each having an L-shaped cross section. The inner leg part 64 has a cutout portion 64A, which is formed by partially cutting out the inner leg part 64.

A reflecting film 68 is formed on the internal surface of the light-guiding member 56. The reflecting film 68 is made of a film of evaporated aluminum, for example.

The light-guiding member 56 is composed of two members (i.e. a first member 70 and a second member 72) combined together, which are plane-symmetrical. FIG. 2 shows the first member 70 only.

A supporter 74 for supporting the circuit board 84 of the circuit unit 82 is formed on the inner surface of the main body 58 of the light-guiding member 56. The supporter 74 includes a first rib 76 and a second rib 78 protruding from the internal surface of the main body 58, and a supporting groove 80 is formed between the rib 76 and the rib 78. The first member 70 has a fitting surface 70A for fitting to the second member 72.

The fitting surfaces of the first member 70 and the second member 72 are fit to each other, and thus the light-guiding member 56 having a cylindrical shape with a bottom is formed, as described above. In this case, in regard to the bottomed cylindrical main body 58 of the light-guiding member 56, the edge surrounding the opening has an annular shape as described above. Thus, the shape of the edge matches the arrangement of the LEDs 44, . . . , 54, which are also arranged annularly. Note that FIG. 1 shows a cross section of the LED lamp 10 in the plane including a line segment connecting the LED 46 and the LED 52.

The inner leg part 64 and the outer leg part 66 of the light-guiding member 56 are inserted in the inner groove 32 and the outer groove 34, respectively. The inner leg part 64 and the outer leg part 66 are attached to the seating 30 by adhesive, which is not depicted. The LEDs 44, . . . , 54 are located within a space 65 between the inner leg part 64 and the outer leg part 66. The light-emitting surfaces of the LEDs face the light-receiving portion 67 of the light-guiding member 56. The light-receiving portion 67 corresponds to the edge of the main body 58 surrounding the opening, and is sandwiched between the inner leg part 64 and the outer leg part 66 of the light-guiding member 56. More specifically, the LEDs 44, . . . , 54 are arranged circumferentially along the edge of the main body 58, so that the light-emitting surfaces of the LEDs 44, . . . , 54 face the light-receiving portion 67 of the light-guiding member 56, which corresponds to the edge of the main body 58 surrounding the opening.

### (7) Circuit Unit

The circuit unit 82 includes a circuit board 84 and an electronic part 86 mounted on the circuit board 84. For simplification, only one electronic part is denoted by the reference number 86. However, there are a plurality of electronic parts, including the electronic part 86. The circuit unit is constituted of the plurality of electronic parts.

The circuit board 84 has a disk-like shape, for example. As shown in FIG. 1, the periphery of the circuit board 84 is inserted in the supporting groove 80 of the light-guiding member 56 and is thereby supported. In other words, the whole body of the circuit unit 82 is housed in the hollow portion of the light-guiding member 56 having a cylindrical shape with a bottom. Note that the circuit unit 82 may be attached to the light-guiding member 56 by adhesive, a screw, a latching structure or the like, instead of being inserted in a groove.

### (8) Globe

The LED lamp 10 has a globe 96 for covering the light-guiding member 56. The globe 96 is made of a translucent material, such as a synthetic resin material or a glass material, for example. The globe 96 has been subject to blasting, spray coating with fine particles of silica or the like, or painting with a white pigment, in order to have a light-diffusion function. Alternatively, the globe 96 may be made of milk-white material.

The globe 96 substantially has a shape of an egg, one end of which is truncated. The periphery around the opening of the globe 96 is inserted in the step-like part 30C, which exists within the large cylindrical part 18 of the holder 12. The step-like part 30C is filled with heatproof adhesive 98. Thus, the seating 30 and the globe 96 are fixed to the holder 12.

In other words, in the LED lamp 10, the envelope 100 is composed of the holder 12, the base 20 and the globe 96, and the envelope 100 houses the plurality of LEDs 44, . . . , 54 and the circuit unit 82. Note that the base 20 of the LED lamp 10 is not necessarily attached to the globe 96 with the holder 12 intervening therebetween.

The envelope may be composed only of the base 20 and the globe 96. If this is the case, the base 20 may be directly attached to the end of the globe 96.

### 2. Electrical Connection

(1) Electrical Connection between Circuit Unit and Base

The circuit unit 82 and the eyelet 24 are electrically connected by a wiring line 88, and the circuit unit 82 and the shell 22 are electrically connected by a wiring line 90. The circuit unit 82 converts the AC power provided via the eyelet 24 and the shell 22, and the wiring line 88 and the wiring line 90 (i.e. the power received from the base 20), to power to be used to cause the LEDs 44, . . . , 54 to emit light, and supply the converted power to the LEDs 44, . . . , 54.

(2) Electrical Connection between Circuit Unit and LED Module

The circuit board 84 and the mounting board 42 are electrically connected via internal wiring lines 92 and 94 inserted in the cutout portion 64A (see FIG. 2) (The connection points between the mounting board 42 and the wiring lines 92 and 94 are not depicted in the drawing).

### 3. Heat Radiation Path

In the LED lamp 10 having the stated structure, heat generated by the LEDs 44, . . . , 54 during the operation is conducted to the base 20 via the mounting board 42, the seating 30 and the holder 12, and is discharged to, via the socket of the lighting fixture to which the LED lamp 10 is attached, other components of the lighting fixture, and further to the ceiling and the wall to which the lighting fixture is attached.

In the LED lamp 10, the circuit unit 82 is housed in the globe 96, which is opposite to the base 20 with respect to the mounting board 42. That is, the circuit unit 82 is not located in the heat conduction path from the LED module 40 to the base 20. Hence, power supplied to the LEDs can be increased without being restricted by the effect of the heat applied to the circuit unit 82. This further increases the brightness.

### 4. Optical Path

Light emitted from each of the annularly arranged LEDs 44, . . . , 54 enters the light-receiving portion 67 of the light-guiding member 56, which corresponds to the edge surrounding the opening of the light-guiding member 56 having a cylindrical shape with a bottom, and travels within the light-guiding member 56 while being repeatedly reflected off the boundary surface between the light-guiding member 56 and the air layer (i.e. the outer circumferential surface of the light-guiding member 56) and the reflecting film 68 formed on the inner circumferential surface of the light-guiding member 56. Then, when the incident angle with respect to the outer circumferential surface is equal to or smaller than the critical angle, a portion of light is emitted outside the light-guiding member 56 according to the incident angle.

The light travelling within the light-guiding member 56 is eventually emitted from the edge (light-emitting portion) that is opposite to the edge surrounding the opening (the light-receiving portion 67). In this example, the edge from which light is emitted (the light-emitting portion) corresponds to the hemisphere surface of the bottomed cylindrical shape and to the cylindrical side surface.

If a lamp is not provided with the light-guiding member 56, light travelling from the LEDs 44, . . . 54 toward the circuit unit 82 is blocked by the circuit unit 82. This decreases the amount of light that reaches the central axis of the globe 96 and the inner surface thereof around the axis. As a result, although the globe 96 has a light-diffusion function, the amount of light travelling in the central axis direction toward the front side is slightly decreased.

In contrast, in regard to this example, light is emitted from the area where would be hidden behind the circuit unit 82 (i.e. the area behind the circuit unit 82) if the light-guiding member 56 is not provided. That is, light is emitted from the light-emitting portion of the light-guiding member 56. Therefore, the decrease in the amount of the light travelling in the central axis direction toward the front side can be reduced as much as possible.

The light emitted from the light-guiding member 56 toward the internal surface of the globe is diffused by the globe 96, and is emitted in various directions from the surface of the globe 96. As a result, the LED lamp 10 is capable of emitting light in all directions.

In the example, the reflecting film 68 is formed on the inner circumferential surface of the light-guiding member 56. However, the reflecting film 68 is not essential. This is because a portion of the light travelling within the light-guiding member 56 is also reflected off the inner circumferential surface and goes toward the light-emitting portion. That is, even a portion of the light emitted toward the hollow portion of the light-guiding member 56 is reflected off the inner circumferential surface, and re-enters the light-guiding member 56 and travels within the light-guiding member 56.

### Embodiment 2

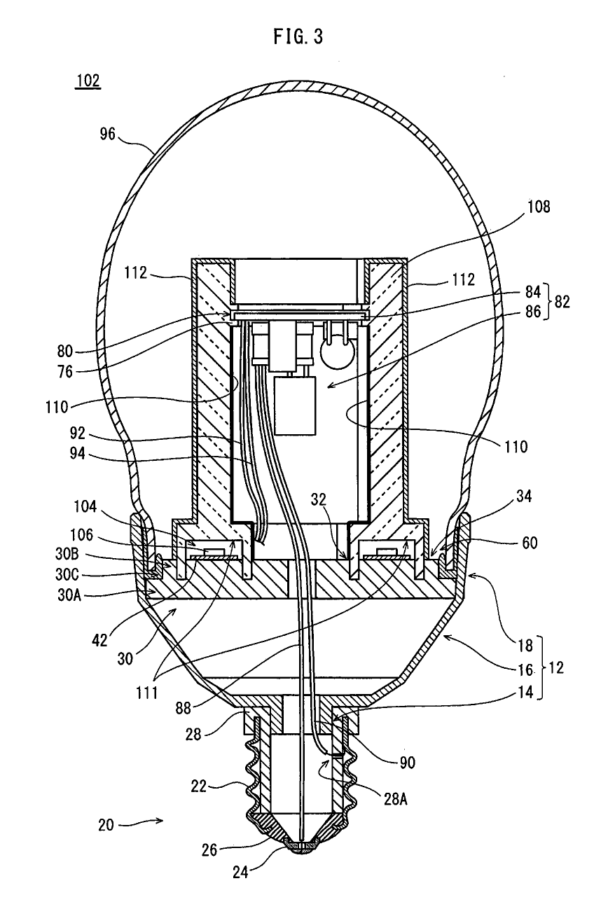

FIG. 3 is a cross-sectional view schematically showing the structure of a bulb-type LED lamp 102 pertaining to Embodiment 2.

Note that the LED lamp 2 basically has the same structure as the LED lamp 10 pertaining to Embodiment 1 except that the LEDs constituting the LED module and the light-guiding member are different from those of the LED lamp 10. In FIG. 3, the components similar to those of the LED lamp 10 are therefore given the same reference signs as the LED lamp 10, and their explanations are omitted. The following mainly describes the differences.

LEDs 106 constituting the LED module 104 pertaining to Embodiment 2 are all blue LEDs, and the yellow phosphor for obtaining white light is formed on the light-guiding member 108. In this example, the same reference sign is given to all the LEDs that constitute the LED module 104.

### 1. Structure

Whereas the light-guiding member 56 (FIG. 1) of Embodiment 1 has a cylindrical shape with a bottom, the light-guiding member 108 of the LED lamp 102 pertaining to Embodiment 2 has a cylindrical shape with open ends.

A reflecting film 110 is formed on an area on the internal surface of the light-guiding member 108. The area is closer to the base 20 than the opposite area with respect to a first rib 76. The first rib 76 forms the supporting groove 80. A yellow phosphor layer 112, which is a wavelength converting layer, is formed on the remaining area of the inner circumferential surface, on the outer circumferential surface, and on the edge from which light is emitted.

### 2. Optical Path

With the LED lamp 102 having the stated structure, blue light emitted from each of the annularly arranged six LEDs 106 enters the edge of the light-guiding member 108 having a cylindrical shape (i.e. the edge closer to the base 20 (the light-receiving portion 111)), which faces the light-emitting surfaces of the LEDs 106, and travels within the light-guiding member 108 while being repeatedly reflected off the boundary surface between the light-guiding member 108 and the phosphor layer 112 (i.e. the outer circumferential surface of the light-guiding member 108) and the reflecting film 110 formed on the inner circumferential surface of the light-guiding member 108. Then, when the incident angle with respect to the outer circumferential surface is equal to or smaller than the critical angle, a portion of light is emitted outside the light-guiding member 108 according to the incident angle. A portion of the blue light is converted to yellow light while passing through the phosphor layer 112, is mixed with the remaining portion of the blue light, which has not been converted, and becomes white light. The white light is emitted from the globe 96, outside the LED lamp 102.

The light travelling within the light-guiding member 108 is eventually emitted from the edge (light-emitting portion) that is opposite to the edge closer to the base 20. In this example, the edge from which light is emitted has an annular shape.

In this case, since a portion of the light emitted from the light-emitting portion has been travelling within the light-guiding member 108 while being reflected repeatedly, the portion of light is emitted with an angle with respect to the central axis of the light-guiding member 108 having a cylindrical shape. As a result, light is emitted in the central axis direction of the globe 96 and also from the internal surface thereof around the axis. Therefore, as with Embodiment 1, the decrease in the amount of the light travelling in the central axis direction toward the front side can be reduced as much as possible in comparison with the case where the light-guiding member 108 is not provided.

Moreover, since the efficiency of the wavelength conversion by the phosphor particles decreases as the temperature increases, the structure of this example, in which the phosphor layer 112 is formed on the light-guiding member 108, is effective for protecting the phosphor against heat while the LEDs are emitting light, and preventing the degradation in efficiency of the wavelength conversion by the phosphor particles.

### Modifications pertaining to Embodiments 1 and 2

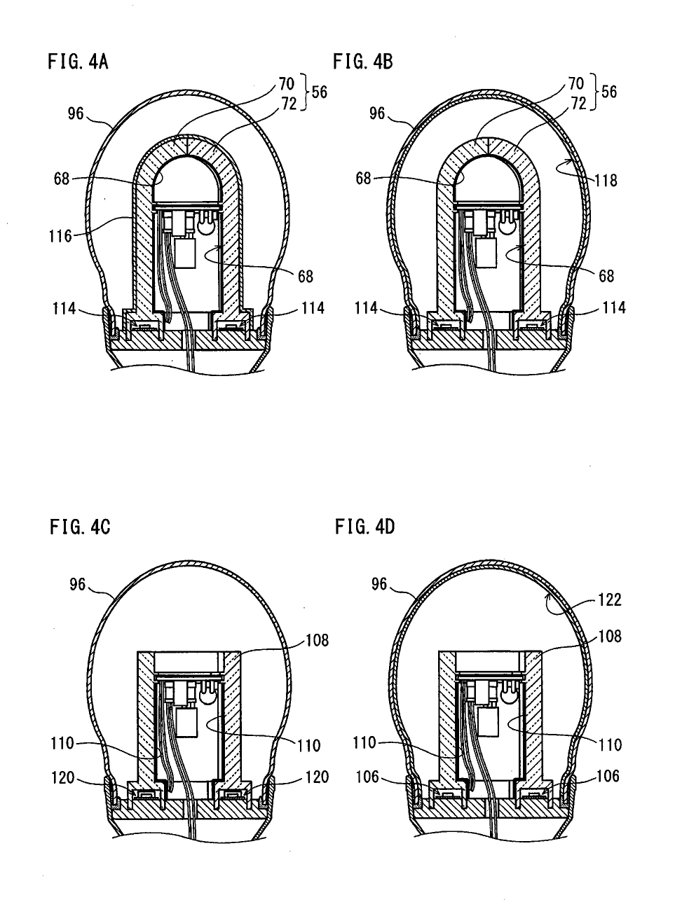

FIGS. 4A and 4B show modifications of Embodiment 1, and FIGS. 4C and 4D show modifications of Embodiment 2. Note that in FIG. 4, only components that need to be explained for showing the differences from other embodiments are given reference signs. Also, the same components as the corresponding embodiment are given the same reference signs.

### 1. Modifications of Light-Guiding Member Pertaining to Embodiment 1

In the example shown in FIG. 4A, blue LEDs 114 are used as LEDs constituting the LED module. Also, a yellow phosphor layer 116, which is a wavelength converting layer for converting blue light emitted by the LEDs 114 to yellow light, is formed on the outer circumferential surface of the light-guiding member 56.

In the example shown in FIG. 4B, blue LEDs 114 are used as LEDs constituting the LED module. Also, a yellow phosphor layer 118, which is a wavelength converting layer for converting blue light emitted by the LEDs 114 to yellow light, is formed on the inner circumferential surface of the globe 96.

### 2. Modifications of Light-Guiding Member Pertaining to Embodiment 2

In the example shown in FIG. 4C, white LEDs 120 are used as LEDs constituting the LED module. The light-guiding member 108 is not provided with a phosphor layer.

In the example shown in FIG. 4D, as with Embodiment 2, blue LEDs 106 are used as LEDs constituting the LED module. A yellow phosphor layer 122 is formed on the inner circumferential surface of the globe 96.

### 3. Modifications of Manner for Supporting Circuit Unit Pertaining to Embodiment 1

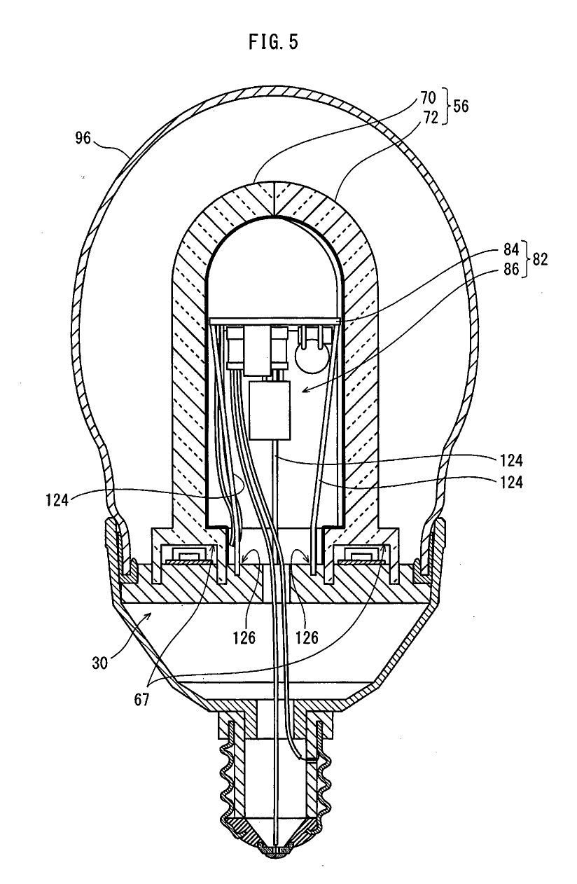

FIG. 5 shows a modification of the manner by which the circuit unit is supported within the hollow portion of the light-guiding member. This example is a modification of Embodiment 1 (FIG. 1).

Whereas the circuit unit 82 in Embodiment 1 is supported by the light-guiding member 56, the circuit unit in this example is supported by four wires 124 (only three wires are shown in FIG. 5).

One ends of the wires 124 are fixed on the insulated portion of the circuit board 84, on which a wiring pattern may be formed. The other ends of the wires 124 are press-fit to mounting holes 126 formed in the seating 30.

Note that although FIG. 5 shows a modification of Embodiment 1, the supporting manner shown in FIG. 5 may be adapted to Embodiment 2, the modifications shown in FIG. 4, and so on.

### 4. Modifications of Mounting Direction of Circuit Board Pertaining to Embodiment 1

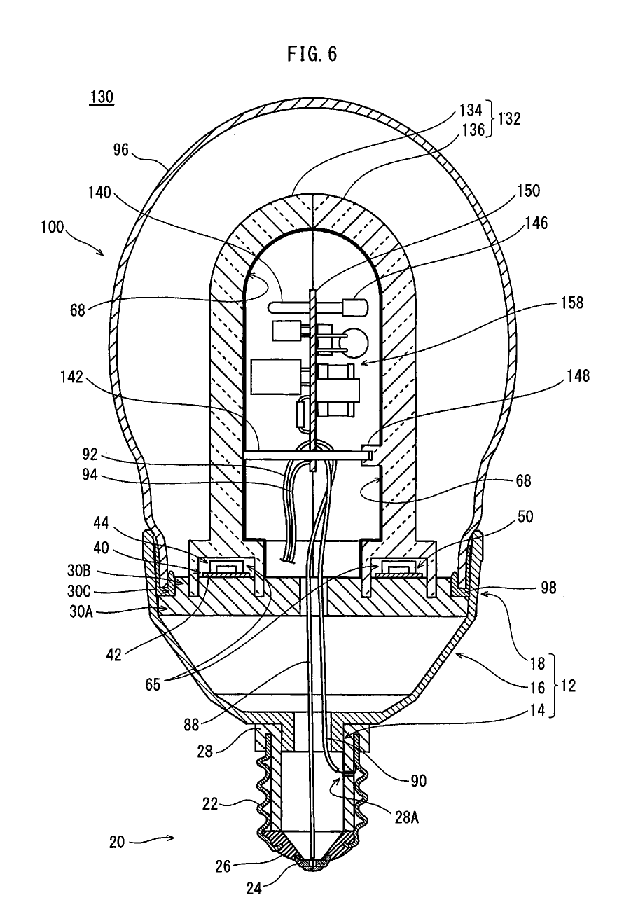

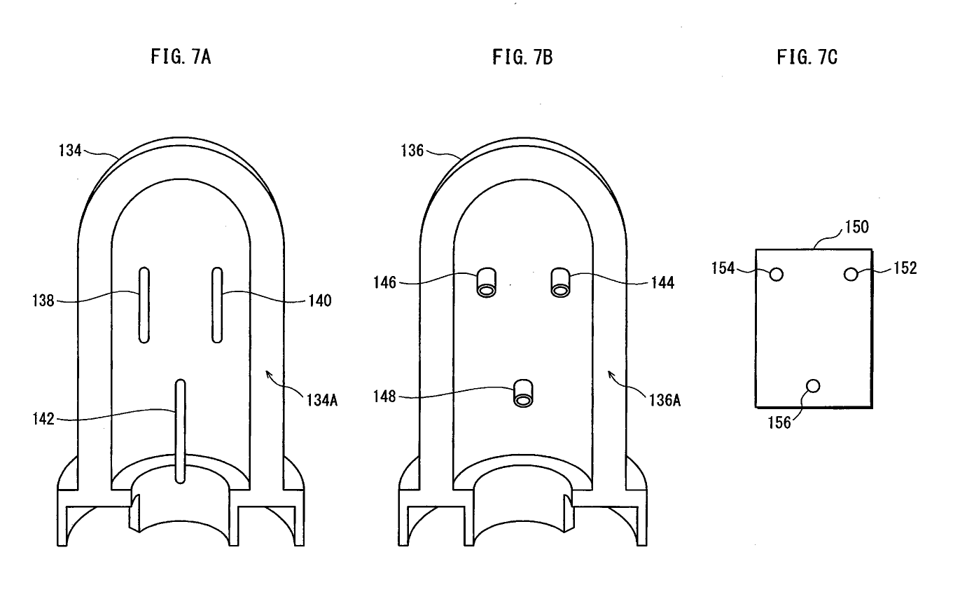

FIG. 6 and FIGS. 7 show modifications of the mounting direction of the circuit unit placed within the hollow portion of the light-guiding member. This example is a modification of Embodiment 1 (FIG. 1 and FIG. 2). This modification is almost the same as Embodiment 1, except that mainly the circuit unit and the light-guiding member (the first member and the second member) are different from those of Embodiment 1. In FIG. 6 and FIGS. 7, the components similar to those shown in FIG. 1 and FIG. 2 are therefore given the same reference signs, and their explanations are omitted. The following mainly describes the differences.

In Embodiment 1, the circuit board 84 is arranged in the direction intersecting with (i.e. perpendicular to) the central axis of the globe 96 (such an arrangement is hereinafter referred to as “horizontal arrangement”). In contrast, in the example shown in FIG. 6, the circuit board 84 is arranged in the direction parallel to the central axis (such an arrangement is hereinafter referred to as “vertical arrangement”).

In the case of the horizontal arrangement, when the circuit board is relatively distant from the LEDs, the distance between each of the electronic parts mounted on one mounting surface of the circuit board and the LEDs are not much different. In contrast, in the case of the vertical arrangement, the distance between each of the electronic parts and the LEDs varies according to the length of the circuit board. Considering the influence of heat generated by the LEDs, the electronic parts may be arranged so that the part less resistant to heat is located farther from the LEDs (i.e. the part more resistant to heat is located closer to the LEDs).

FIG. 7A and FIG. 7B are perspective views respectively showing a first member 134 and a second member 136, both included in a light-guiding member 132 of an LED lamp 130 pertaining to the modification.

The first member 134 has three pins 138, 140 and 142, which are provided on the inner circumferential surface thereof in parallel. The second member 136 has bosses 144, 146 and 148, which protrude from the inner circumferential surface thereof and engage with the tips of the pins 138, 140 and 142, respectively.

FIG. 7C is a plan view of a circuit board 150, on which electronic parts have not been mounted yet. The circuit board 150 has through holes 152, 154 and 156 located in accordance with the intervals between the pins 138, 140, and 142.

In this example, the circuit unit 158 is attached to the first member 134 by passing the pins 138, 140 and 141 through the through holes 152, 154 and 156 of the circuit board 150, respectively, and then the tips of the pins 138, 140 and 141 are engaged with the bosses 144, 146 and 148, respectively. Also, the first member 134 and the second member 136 are combined by fitting the fitting surfaces 134A and 136A to each other. Thus, the light-guiding member 132 having a cylindrical shape with a bottom and housing the circuit unit 158 in the hollow portion thereof is formed.

### Embodiment 3

### 1. Structure

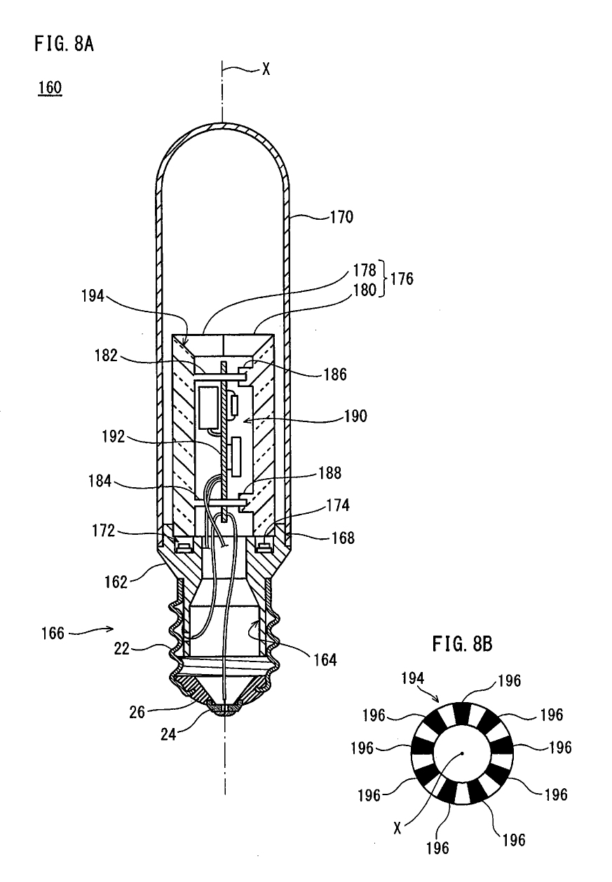

FIG. 8A is a cross-sectional view schematically showing the structure of an LED lamp 160 pertaining to Embodiment 3. The LED lamp 160 has basically the same structure as the LED lamps 10 and 102 pertaining to Embodiments 1 and 2. The LED lamp 160, however, is designed to have a shape similar to common HID lamps (high-intensity discharge lamps) so as to be used as a light source that can substitute the HID lamps. In FIG. 8A, the components similar to those of the LED lamp 10 pertaining to Embodiment 1 shown in FIG. 1 are therefore given the same reference signs as the LED lamp 10, and their detailed explanations are omitted. The following mainly describes the differences

The LED lamp 160 has a seating 162 having a cylindrical shape. The seating 162 is made of a heat-conducting insulating material, such as aluminum nitride (AlN). The shell 22 of a base 164 is inserted in a bottom cylindrical part 164 of the seating 162. The bottom cylindrical part 164 is located at the bottom of the seating 162 and has substantially a cylindrical shape. The bottom cylindrical part 164 serves as an equivalent to the second insulator 28 (FIG. 1) of Embodiment 1.

The edge surrounding an opening of a globe 170 having a cylindrical shape with a bottom is inserted into an external step-like part 168 formed along the periphery of the upper part of the seating 162. The globe 170 has a similar shape to an outer tube of a HID lamp (i.e. a straight-tube shape), and is made of a translucent material, such as a synthetic resin material or a glass material, for example. The central axis of the globe 170 coincides with the central axis of the base 166. This central axis is hereinafter referred to as “lamp axis X”.

An LED module 174 is mounted on the bottom of a circular groove 172, which is also formed in the upper part of the seating 162. The LED module 174 has basically the same structure as the LED module 40 (FIG. 1, FIG. 2) of Embodiment 1. That is, the LED module 174 includes a mounting board, which is made from a printed wiring board having an annular shape, a plurality of blue LED chips, which are mounted on the mounting board and electrically connected in series, and a yellow phosphor annularly covering the LED chips.

The LED lamp 160 has a light-guiding member 176 having a tubular shape (cylindrical shape in this example) and disposed such that one edge thereof covers the opening of the circular groove 172. As with the light-guiding member 108 (FIG. 3) of Embodiment 2, the light-guiding member 176 is composed of a first member 178 and a second member 180, each having a halved-cylinder shape. The first member 178 has pins 182 and 184, which protrude from the inner circumferential surface thereof. The second member 180 has bosses 186 and 188, which protrude from the inner circumferential surface thereof and correspond to the pins 182 and 184. As with the case of the LED lamp 130 pertaining to the modifications (FIG. 6 and FIG. 7), the pins 182 and 184 supports the circuit board 192 of the circuit unit 190 within the light-guiding member 176.

The edge 194 of the light-guiding member 176, which is farther from the LED module 174 than the other edge is, is located substantially in the middle of the length of the globe 170 in the direction of the lamp axis X. This is because the optical center point of HID lamps is generally at this position.

The edge 194 is tapered as depicted in the drawing. FIG. 8B shows the edge 194 viewed in the direction of the lamp axis X. Reflecting films 196 are radially formed on the edge 194. Each reflecting film 196 is made of a film of evaporated aluminum, for example.

### 2. Optical Path

With the LED lamp 160 having the stated structure, light emitted from the LED module 174 enters the edge of the light-guiding member 176 having a cylindrical shape (i.e. the edge closer to the base 166 (the light-receiving portion)), which faces the LED module 174, and travels within the light-guiding member 176 while being repeatedly reflected off the boundary surface between the light-guiding member 176 and the air layer. Then, when the incident angle with respect to the boundary surface is equal to or smaller than the critical angle, a portion of light is emitted outside the light-guiding member 176 according to the incident angle. The light travelling within the light-guiding member 176 is eventually emitted from the edge (light-emitting portion) that is opposite to the edge closer to the base 166.

In this case, since a portion of the light emitted from the light-emitting portion has been travelling within the light-guiding member 176 while being reflected repeatedly, the portion of light is emitted with an angle with respect to the central axis (the lamp axis X) of the light-guiding member 176 having a cylindrical shape (i.e. wide light is emitted). To make the light even wider, this example is equipped with the reflecting films 196. The reflecting films 196 are provided to increase the percentage of wide light that is emitted with a greater angle than the output angle obtained by the reflection within the light-guiding member 176 (i.e. the angle with respect to the lamp axis X). Here, the angle formed by the reflecting films 196 with respect to the lamp axis X is determined according to a required light distribution characteristic.

The pattern of the reflecting films is not limited to the radial patterns. For example, the reflecting film may be formed in a checkered pattern or be formed concentrically around the lamp axis X. In a word, any pattern is acceptable only if a portion of the light having traveled within the light-guiding member 176 is emitted from the edge 195 in the direction according to the reflecting angle within the light-guiding member 176, and a portion of the remaining light is emitted from the edge 194 in a desired direction intersecting with the lamp axis X (i.e. the direction determined according to the angle formed by the reflecting films with respect to the lamp axis X).

### Embodiment 4

The following explains Embodiment 4 in detail with reference to the drawings. The lamp pertaining to Embodiment 4 is designed to have the same shape and functions as a halogen lamp having a mirror, for example. Generally, halogen lamps having a reflecting mirror achieve a higher brightness than incandescent light bulbs. Hence, to obtain the brightness at the same level as the halogen lamps by using conventional technology, it is necessary to increase the number of LEDs. However, this increases the amount of heat generated by the LED module, and thus the problem of reduced lifetime due to thermal destruction of the electronic parts will be more prominent. Also, LEDs emit directional light, whereas halogen lamps emit wide light from a tungsten filament. For the reasons above, the desired light distribution characteristic in the case of using the reflecting mirror can hardly be obtained by simply placing the LEDs on the bottom part of the reflecting mirror so that the LEDs emit light in the optical axis direction of the reflecting mirror. The lamp pertaining to Embodiment 4 has a structure for solving the problems above.

### 1. Structure

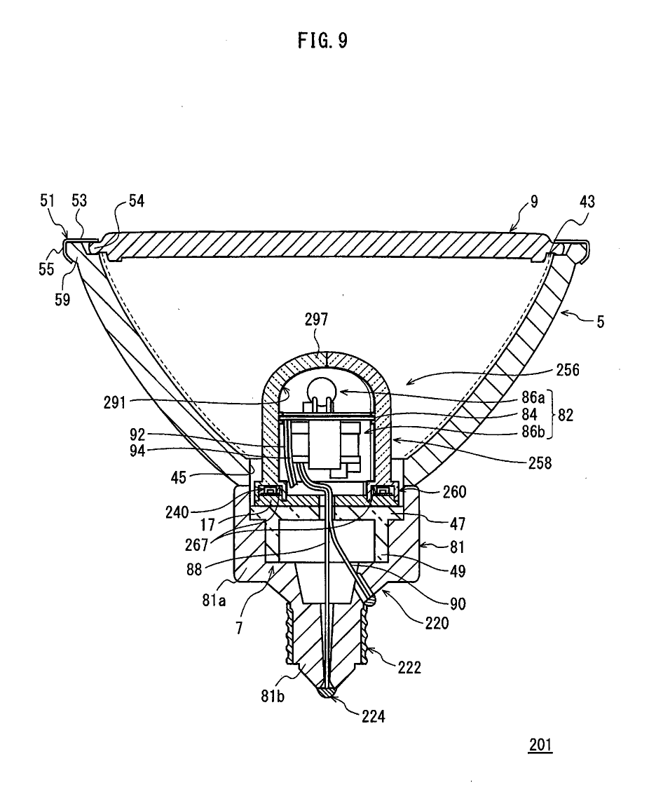

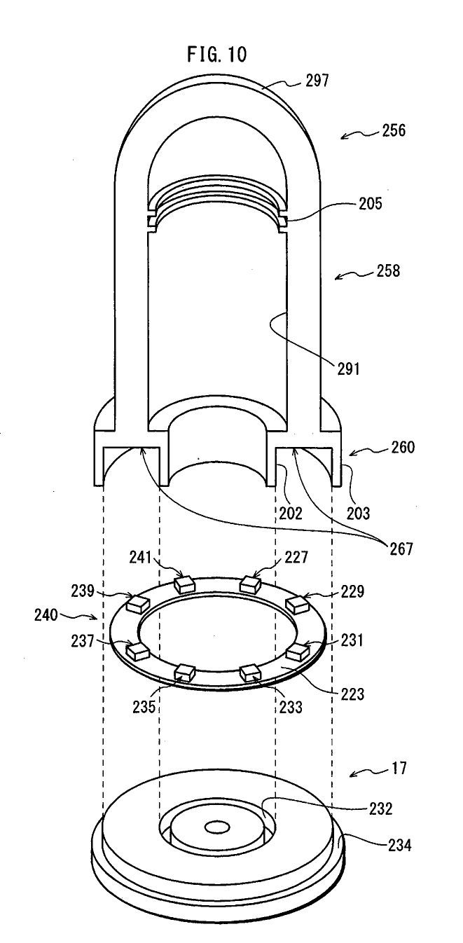

FIG. 9 is a cross-sectional view schematically showing the structure of an LED lamp pertaining to Embodiment 4. FIG. 10 is a perspective view showing a seating, an LED module, and a light-guiding member.

The lamp 201 includes an LED module 240, a reflecting mirror 5, a front panel 9, a circuit unit 82, a base 220, a seating 7, and a light-guiding member 256. The LED module 240 includes LEDs. The reflecting mirror 5 houses therein the LED module 240. The front panel 9 is located at one end of the reflecting mirror 5. The circuit unit 82 is for lighting the LEDs. The base 220 is electrically connected to the circuit unit 82. The seating 7 is attached to the base 220. The light-guiding member 256 guides the light emitted from the LEDs. The lamp 201 also includes a seating member 17 on which the light-guiding member 256 is provided to stand. The top part 297 (light-emitting portion) of the light-guiding member 256 is located at or near the focal point of the reflecting mirror 5, and serves as a light-emitting point for the light guided within the light-guiding member 256.

The envelope of the LED lamp 201 is composed of the base 220, the reflecting mirror 5 and the front panel 9. The plurality of LEDs and the circuit unit 82 are housed in the envelope. The base 220 is directly attached to the reflecting mirror 5. It does not matter whether the reflecting mirror 5 has an opening or not (i.e. the reflecting mirror 5 may form a closed system or an open system). Also, the envelope may be composed of the base 220, the reflecting mirror 5, the front panel 9 and at least one other member.

If this is the case, the base 220 may be attached to the reflecting mirror 5 with another member intervening therebetween.

### (1) Base

The base 220 is attached to the base part of the reflecting mirror 5. There are various types of bases, and a shell 222 of the base 220 in this example is of an Edison type, such as the E11 type. However, this is not essential.

The base 220 includes a main body 81, a shell 222, and an eyelet 224. The main body 81 is attached to the reflecting mirror 5 and the seating 7. The shell 222 is attached to the main body 81. The eyelet 224 is provided to the opposite edge of the main body 81 with respect to the reflecting mirror 5. The shell 222 and the eyelet 224 are electrically connected to the circuit unit 82 via the wiring line 90 and the wiring line 88, respectively. The main body 81 is hollow, and the wiring lines 88 and 90 run through the hollow. The end of the hollow closer to the shell 222 is covered with a heat-conductive material, such as silicone resin.

The main body 81 is made of an insulative material, and is composed of a large-diameter cylindrical part 81a and a small-diameter cylindrical part 81b having a smaller diameter than the large-diameter cylindrical part 81a. The shape and size of the bore of the large-diameter cylindrical part 81a correspond to the shape and size of the seating 7. Specifically, the cross section of the large-diameter cylindrical part 81a has a step-like shape, since the shape of the large-diameter cylindrical part 81a corresponds to the shape of the disc part 47 and the cylindrical part 49 of the seating 7. The small-diameter cylindrical part 81b extends from the edge closer to the eyelet 224 of the large-diameter cylindrical part 81a. Note that the cross section of the large-diameter cylindrical part 81a and the cross section of the small-diameter cylindrical part 81b have an annular shape.

The shell 222 has a threaded outer circumferential surface, and is attached to the small-diameter cylindrical part 81b. Note that the shell 222 is fixed to the small-diameter cylindrical part 81b with adhesive. To the eyelet 224, a wiring line 90 is soldered. The wiring line 90 passes inside the small-diameter cylindrical part 81b.

### (2) Seating

The seating 7 is composed of a disc part 47 and a cylindrical part 49. The disc part 47 has a plate-like shape and has a hole provided in the center thereof. The wiring lines 88 and 90 pass through the hole. The shape of the seating 7 is not limited to the shape described above, and any shapes are acceptable. A base 220 is attached to the cylindrical part 49 of the seating 7.

In this Embodiment, the cylindrical part 49 extends from the disc part 47. The center point of the disc part 47 is in the central axis of the cylindrical part 49. The wiring lines 88 and 90 extended from the direction of the base 220 pass through the hole of the disc part 47, and are connected to the circuit unit 82.

A seating member 17 is mounted on the seating 7. Specifically, the seating member 17 is mounted on the surface closer to the circuit unit 82 of the disc part 47. The seating member 17 is mounted on the seating 7 by a screw, adhesive, a latching structure or the like. Note that the center point of the seating member 17 coincides with the center point of the disc part 47 on the design basis. Specifically, the seating member 17 and the disc part 47 are mounted on the seating 7 such that the hole of the seating member 17 coincides with the hole of the disc part 47.

### (3) LED Module

As shown in FIG. 10, the LED module 240 includes a mounting board 223, which is made from a printed wiring board having an annular shape, and eight LEDs mounted on the mounting board 223, namely LEDs 227, 229, 231, 233, 235, 237, 239, and 241. On the mounting board 223, LEDs 227, . . . , 241 are mounted every 45° around the center point of the ring. In other words, the arrangement of the LEDs 227, . . ., 241 corresponds to the shape of the mounting board 223, and they are arranged annularly. The LED module 240 is placed within the reflecting mirror 5 so as to emit light in the direction away from the base 220. Note that the LEDs 227, . . . , 241 are white LEDs.

### (4) Light-Guiding Member

The light-guiding member 256 has a cylindrical shape, and is provided to stand on the seating member 17 such that the top part 297 (light-emitting portion) of the light-guiding member 256 faces in the direction away from the base 220. A reflecting film 291 is formed on the internal surface of the light-guiding member 56 so that incident light from the LED module 240 is reflected off the internal surface of the light-guiding member 256 and guided to the top part 297.

The light-guiding member 256 has a main body 258 and a leg 260. The main body 258 has a shape of a cylinder with closed ends. The internal surface thereof has a supporting groove 205 used for attaching the circuit unit 82 to the light-guiding member 256. The supporting groove 205 is a groove formed along the internal surface of the light-guiding member 256.

In order to locate the focal point of the reflecting mirror 5 within the top part 297, the top part 297 is located in a focal area (which refers to an area including the focal point, or an area not including the focal point but located near the focal point).The top part 297 has been subject to frosting, and achieves a light-diffusion effect. Although the top part 297 in the present embodiment has a hemisphere shape, it may have a different shape, such as semielliptical shape.

The leg 260 extends from the inner and outer circumferences of the edge that is farther from the top part 297 than the other edge is, and includes an inner leg part 202 and an outer leg part 203, each having an L-shaped cross section. The edge farther from the top part 297 has an annular shape, and thus the shape of the edge matches the arrangement of the LEDs 227, . . . , 241, which are also arranged annularly. That is, the leg 260 of the light-guiding member 256 has an annular shape that matches the arrangement of the LEDs 227, . . . , 241. Note that when the arrangement of the LEDs 227, . . . , 241 is altered, the shape of the leg 260 should be changed accordingly.

### (5) Circuit Unit

The circuit unit 82 is composed of a circuit board 84 and various types of electronic parts mounted on the circuit board 84, such as 86a and 86b. The circuit unit 82 is housed in the light-guiding member 256. Specifically, the periphery of the circuit board 84 is inserted in the supporting groove 205 of the light-guiding member 256 and is thereby supported. The circuit unit 82 and the base 220 are electrically connected via the wiring lines 88 and 90. The circuit unit 82 receives electricity from the base 220, and lights the LED module 240.

### (6) Seating Member

The seating member 17 has a surface on which the light-guiding member 256 and the LED module 240 are mounted. The surface is closer to the opening 43 of the reflecting mirror than the opposite surface is. The opposite surface is in contact with the seating 7. As shown in FIG. 10, the seating member 17 has an inner groove 232 and an outer groove 234, into which the leg 260 of the light-guiding member 256 are fit. The inner leg part 202 and the outer leg part 203 of the light-guiding member 256 are inserted in the inner groove 232 and the outer groove 234, respectively. The inner leg part 202 and the outer leg part 203 are attached to the seating member 17 by adhesive, which is not depicted. The seating member 17 is provided with a hole at the center thereof, through which the wiring lines 88 and 90 pass.

(7) Reflecting Mirror The reflecting mirror 5 is similar to reflecting mirrors used in halogen lamps.

Although the shape of the reflecting mirror 5 is not limited to any particular shape, the reflecting mirror 5 used in this example has an opening in one end, and the other end has a smaller opening than the one end. Furthermore, the reflecting mirror 5 has a bowl-like shape with a reflecting surface on the internal surface thereof That is, the reflecting mirror 5 has a bowl-like shape and one end thereof is provided with an opening 43, and the part corresponding to the bottom of the bowl is provided with an opening 45. The reflecting mirror 5 is made of glass, ceramic, metal, or resin, for example. The reflecting surface is made of a metal film, white resin, or translucent glass or resin, for example. When the reflecting surface is made of translucent glass or resin, it can produce leak light.

The open end of the reflecting mirror 5 surrounding the opening 45 is attached to the main body 81 of the base 220 by adhesive. Note that the reflecting mirror 5 does not necessary have a bowl-like shape, and may have a funnel-like shape. Light emitted by the LED module 240 passes through the light-guiding member 256, and eventually exits from the opening 43 of the reflecting mirror 5.

The reflecting surface of the reflecting mirror 5 may be paraboloidal or spheroidal. When the reflecting surface of the reflecting mirror 5 is paraboloidal, the incident light to the reflecting surface will be parallel light.

On the other hand, when the reflecting surface of the reflecting mirror 5 is spheroidal, the light emitted from the first focal point of the reflecting mirror 5 (corresponding to the “focal point” of the present invention, which is hereinafter simply referred to as “focal point”) and travels toward the reflecting surface is reflected off the reflecting surface so as to be concentrated to the second focal point.

### (8) Front Panel

The front panel 9 is made of a translucent material, and covers the opening 43 of the reflecting mirror 5. The front panel 9 therefore has a shape corresponding to the shape of the opening 43 of the reflecting mirror 5, specifically, a disk-like shape. The front panel may be made of glass, resin, or the like.

Attachment of the front panel 9 to the reflecting mirror 5 is not limited to any particular manner. For example, an attachment member 51 may be used for the attachment. The attachment member 51 includes, for example, an annular part 53 having an annular shape, and engagement parts 55 provided at a plurality of positions on the annular part 53. The front panel 9 is attached to the reflecting mirror 5 by the engagement parts 55 engaging with a flange 59 of the opening 43 of the reflecting mirror 5 such that the annular part 53 is in contact with a periphery 54 of the front panel 9. When the light-guiding member 256, for example, is broken, the front panel prevents its debris from falling.

### 2. Electrical Connection

As shown in FIG. 9, the circuit unit 82 and the base 220 are connected via the wiring lines 88 and 90. The one ends of the wiring lines 88 and 90 are connected to the base 220, and the other ends are connected to the circuit unit 82. The LED module 240 and the circuit unit 82 are connected via the wiring lines 92 and 94.

### 3. Heat Radiation Path

Since the LED lamp 201 has the stated structure, heat generated by the LEDs 227, . . . , 241 is conducted from the seating 7 to the base 20, and the heat conducted to the base 20 is radiated from the lighting fixture, the wall, and the ceiling via the socket of the lighting fixture.

Hence, although heat generated by the LEDs 227, . . . , 241 during operation increases when the current applied to the LEDs 227, . . . , 241 is increased to improve the brightness, the heat is conducted from the base 220 to the lighting apparatus.

### 4. Optical Path

The light emitted by the LEDs 227, . . . , 241 is incident to the surface (the light-receiving portion 267) that is opposite to the top part 297 of the light-guiding member 256, and travels within the light-guiding member 256. The light travelling within the light-guiding member 256 is eventually emitted from the top part 297 (the light-emitting portion) of the light-guiding member 256. Since a portion of light emitted from the top part 297 has been travelling within the light-guiding member 256 while being reflected repeatedly, the portion of light is radially emitted outside from the top part 297 via the front panel 9. The remaining portion of light reaches the reflecting mirror 5. Then, the light reflected off the reflecting surface, which is paraboloidal, is concentrated, and is emitted outside via the front panel 9.

### 5. Effects

In the present embodiment, the circuit unit 82 is provided within the light-guiding member 256. Hence, space for housing the circuit unit 82 is not required between the seating 7 and the base 220. This allows the LED module 240 to be located close to the base 220, and allows the use of the reflecting mirror 5 having a shape and a size similar to reflecting mirror for halogen light bulbs. Consequently, the LED lamp 201 having the stated structure can be fit to conventional lighting fixtures for halogen light bulbs at the rate of approximately 100%.

Furthermore, the circuit unit 82 is located within the light-guiding member 256 on the side farther from the base 220, and the circuit unit 82 including heat-sensitive electronic parts is distanced from the LED module 40 which generates a large amount of heat. With such a structure, even when the temperature of the LED module 240 rises, the circuit unit 82 is less affected by the temperature rise, and the electronic parts of the circuit unit 82 are prevented from being damaged by heat. This comparatively extends the lifetime of the LED lamp 201.

Furthermore, light is radially emitted from the top part 297 of the light-guiding member 256, and the top part 297 is located in the focal area of the reflecting mirror 5. Hence, light is radially emitted from the focal point of the reflecting mirror 5. This allows light to efficiently reach the object, and improves the illuminance.

### Embodiment 5

In Embodiment 4, white LEDs are used as semiconductor light-emitting elements which serve as light emitters. On the other hand, in Embodiment 5 which is described next, blue LEDs are used as semiconductor light-emitting elements. In addition, Embodiment 5 does not use the seating member 17, and the light-guiding member 56 is provided to stand on a disc part 347, which is the surface of a seating 307. Note that same reference signs are applied to the same elements as in Embodiments 1-4 described above.

### (1) Structure

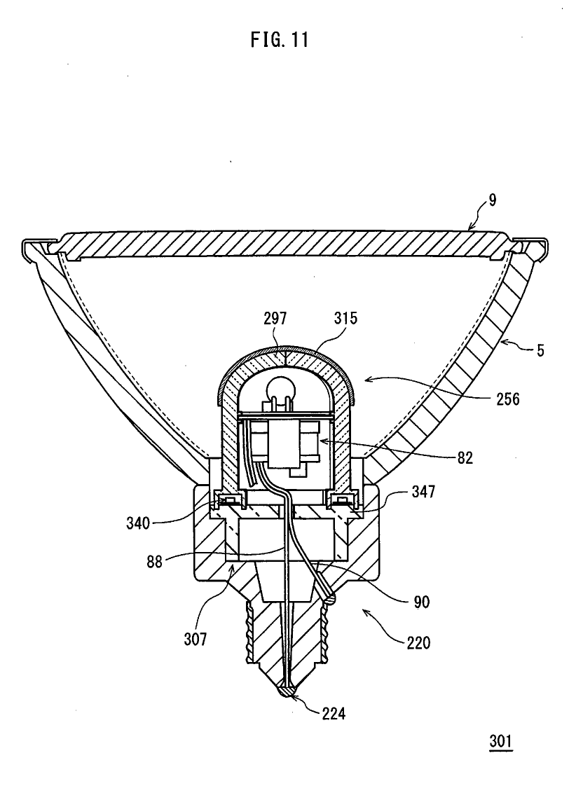

FIG. 11 is a cross-sectional view showing the structure of an LED lamp 301 pertaining to Embodiment 5.

The LED lamp 301 pertaining to Embodiment 5 includes an LED module 340, a reflecting mirror 5, a seating 307, a front panel 9, a circuit unit 82, a base 220, and a light-guiding member 256. The LED module 340 is composed of a plurality of blue LEDs and a mounting board. A yellow phosphor layer 315 is formed on the surface of the top part 297 (the light-emitting portion) of the light-guiding member 256. The yellow phosphor layer 315 is used for obtaining white light from blue light emitted by the LED module 340.

The blue light emitted by the LED module 340 travels within the light-guiding member 256, and is emitted from the top part 297 of the light-guiding member 256. When emitted from the top part 297, the blue light is mixed with the color of the yellow phosphor, and thus exhibits white color. The light then reaches the reflecting mirror 5 and the front panel 9. The LED module 340 is directly disposed on the disc part 347, which is the surface of the seating 307.

The light-guiding member 256 is provided to stand directly on the disc part 347, which is the surface of the seating 307. Specifically, a groove is provided in the surface of the seating 307, and the leg 260 of the light-guiding member 256 is fit into the grove. The light-guiding member 256 thus stands on the seating 307.

### (2) Effects

With the stated structure, the man-hour required for assembling the lamp can be reduced, because the seating member 17 used in Embodiment 4 is not used in this structure.

Moreover, as with Embodiment 2, since the phosphor layer 315 is formed on the light-guiding member 256, this structure is effective for protecting the phosphor against heat while the LEDs are emitting light, and preventing the degradation in efficiency of the wavelength conversion by the phosphor particles.

### Embodiment 6

The following describes Embodiment 6, with reference to the drawings. Note that same reference signs are applied to the same elements as in Embodiments 1-5 described above.

### 1. Structure

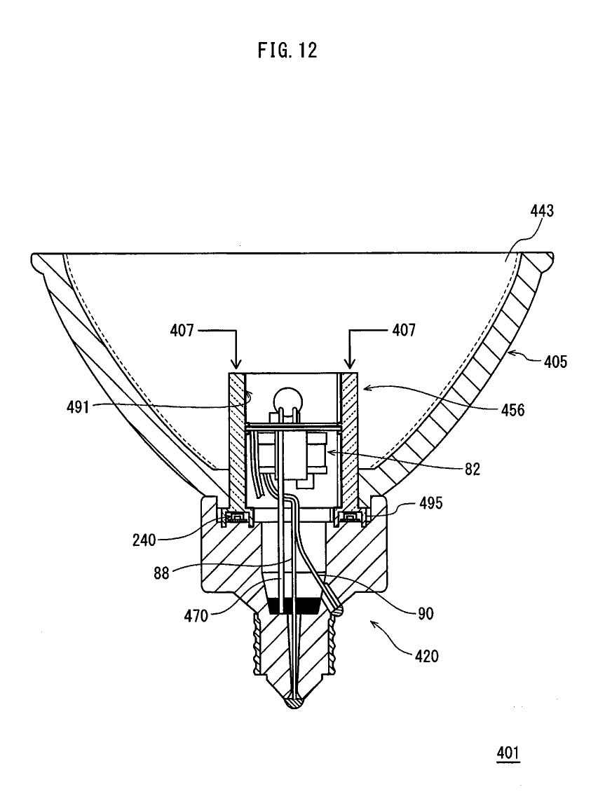

FIG. 12 is a cross-sectional view showing the structure of an LED lamp 401 pertaining to Embodiment 6.

The LED lamp 401 pertaining to Embodiment 6 includes an LED module 240, a reflecting mirror 405, a circuit unit 82, a base 420, and a light-guiding member 456.

The entire body of the light-guiding member 456, except the leg 495, has a cylindrical shape, and the top part 407 has a cylindrical shape as well. The circumferential surface of the top part 407 has been subject to frosting, and achieves a light-diffusion effect. A reflecting film 491 is formed on the internal surface of the light-guiding member 456.

The light-guiding member 456 is provided to stand directly on the base 420, and neither the seating 7 nor the seating member 17 is used. Specifically, a groove is provided in the surface of the base, and the leg 495 of the light-guiding member 456 is fit into the grove. The light-guiding member 456 thus stands on the base 420. The LED module 240 is provided directly on the base 420.

A conductive member 470 having a rod-like or columnar shape is provided between the circuit unit 82 and the base 420. The conductive member 470 conducts heat generated by the circuit unit 82 to the base 420. The conductive member 470 is located between the circuit unit 82 and the base 420 so that one end of the conductive member 470 is thermally connected to the circuit unit 82, and the other end is thermally connected to the base 20. A resin 472 is injected in a portion of the space between the internal surface of the base 420 and the conductive member 470.

Considering the purpose of conducting the heat generated by the circuit unit 82 to the base 420 and reducing the heat load on the circuit unit 82, it is preferable that the conductive member is made of a material that has a high thermal conductivity. However, any heat conductive materials can at least reduce the temperature rise of the circuit unit 82. Therefore, a conductive glass material, ceramic or the like may be used as the conductive member.

Also, the shape of the conductive member 470 is not limited to the rod-like shape. The conductive member 470 may have a tubular shape with a hollow portion, or may be a metal wire, such as a lead wire. Although one end of the conductive member 470 is connected to the base 420 in the description above, it may be connected to a member other than the base 420, such as the reflecting mirror. Also, one end of the conductive member may be connected to a member other than the circuit board, and it may be connected to the electronic part that reaches the highest temperature among the electronic parts mounted on the circuit board.

In the present embodiment, the front panel 9 is not provided on the opening 443 of the reflecting mirror 405, and the opening 443 remains open. Thus, the base 420 and the reflecting mirror 405 constitute the envelope. The reflecting surface of the reflecting mirror 405 is paraboloidal, and the incident light to the reflecting surface is reflected to be parallel light, and is emitted outside.

### 2. Effects

The man-hour required for assembling the lamp can be reduced, because the seating member 17, the seating 7 and the front panel 9 are not used in this structure.

Since the front panel 9 is not provided, the heat generated by the LED module 240 can be effectively radiated. Moreover, since the conductive member 470 is provided, the heat generated by the LED module 240 can be effectively conducted to the base 420.

### Embodiment 7

The following describes Embodiment 7, with reference to the drawings. Note that the same reference signs are applied to the same elements as in Embodiments 1-6 described above.

### 1. Structure

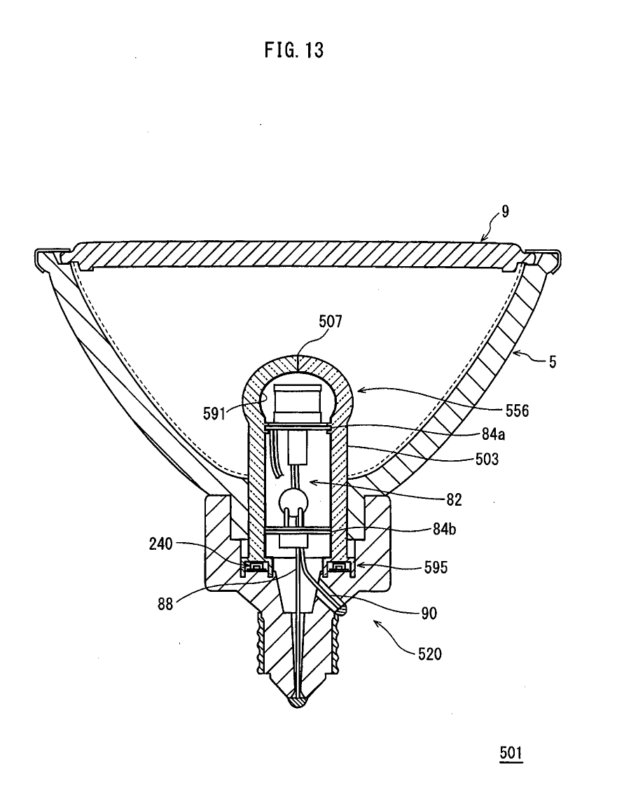

FIG. 13 is a cross-sectional view showing the structure of an LED lamp 501 pertaining to Embodiment 7.

The LED lamp 501 pertaining to Embodiment 7 includes an LED module 240, a reflecting mirror 5, a front panel 9, a circuit unit 82, a base 520, and a light-guiding member 556. Each of the LEDs is composed of a blue LED and a yellow phosphor covering the LED, and emits white light (white LED).

The top part 507 (the light-emitting portion) of the light-guiding member 556 has a dome-like shape whose outer diameter is greater than the outer diameter of the cylindrical part 503. The top part 507 has been subject to frosting, and achieves a light-diffusion effect. A reflecting film 591 is formed on the internal surface of the light-guiding member 556. The light-guiding member 556 is provided to stand directly on the base 520, and neither the seating 7 nor the seating member 17 is used. Specifically, a groove is provided in the surface of the base 520, and the leg 595 of the light-guiding member 556 is fit into the grove. The light-guiding member 556 thus stands on the base 520. The circuit unit 82 includes two circuit boards 84a and 84b and electronic parts mounted on the top surface and the bottom surface of each of the circuit boards.

In the present embodiment, the base 520 and the reflecting mirror 5 constitute the envelope.

### 2. Effects

The man-hour required for assembling the lamp can be reduced, because the light-guiding member 556 is provided to stand directly on the base 220, and the seating member 17 and the seating 7 are not used in this structure.

### Embodiment 8

In the embodiment described above, the LED module is provided on the leg of the light-guiding member. On the other hand, in Embodiment 8 described next, the reflecting surface of the reflecting mirror, as a seating, is provided in addition to the LED module, and the LEDs are arranged annularly. Note that same reference signs are applied to the same elements as in Embodiments 1-7 described above.

### 1. Structure

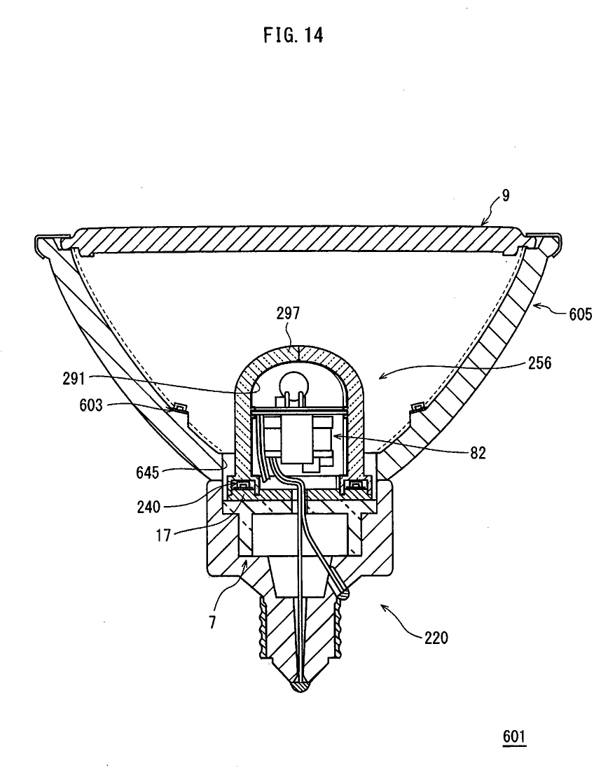

FIG. 14 is a cross-sectional view showing the structure of an LED lamp 601 pertaining to Embodiment 8.

The LED lamp 601 pertaining to Embodiment 8 includes an LED module 240, a reflecting mirror 605, a seating 7, a front panel 9, a circuit unit 82, a base 220, and a light-guiding member 256, a seating member 17 and an LED module 603. Each of the LEDs is composed of a blue LED and a yellow phosphor covering the LED, and emits white light (white LED).

The reflecting mirror 605 has a bowl-like shape and one end thereof is provided with an opening that is covered with the front panel 9, and the part corresponding to the bottom of the bowl is provided with an opening 645. A mound is provided at a position on the inner circumferential surface of the reflecting mirror 605, where is closer to the base 220 than to the top part 297 of the light-guiding member 256. The mound serves as the seating. The LED module 603 is arranged annularly on the seating provided on the reflecting mirror 605. It is preferable that the LED module 603 is located closer to the base 220 than to the top part 297, which is the light-emitting portion of the light-guiding member 256. Such a structure prevents the LED module 603 from blocking the light emitted from the top part 297.

### 2. Effects

Since a large number of LEDs can be provided, the stated structure increases the amount of light that can be produced by the LED lamp 601.

### Embodiment 9

The following explains Embodiment 9 in detail with reference to the drawings.

### 1 Overall Structure

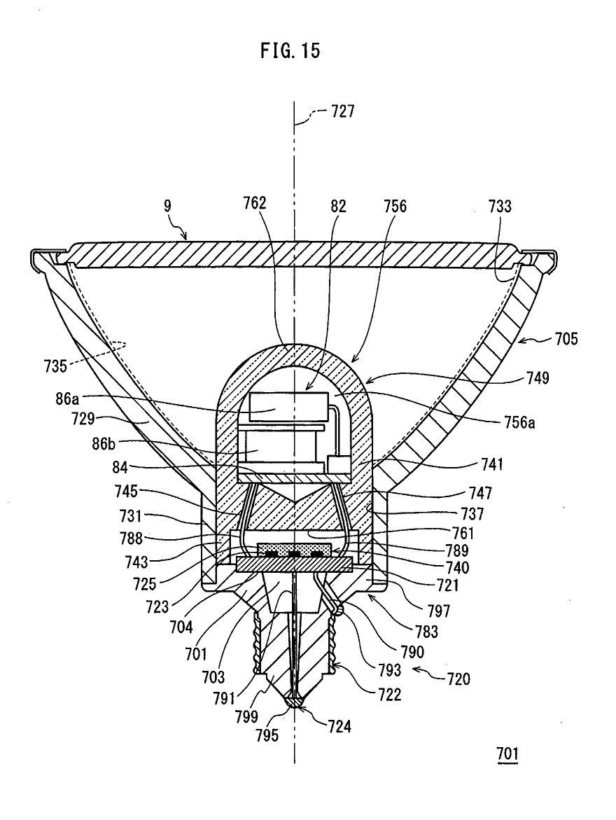

FIG. 15 is a cross-sectional view showing the structure of an LED lamp 701 pertaining to Embodiment 9.

The LED lamp 701 includes: an LED module 740; a reflecting mirror 705 that houses therein the LED module 740; a light-guiding member 756 that has a columnar shape and guides the light emitted by the LED module 740 to the focal area of the reflecting mirror 705; a front panel 9 provided on the open end of the reflecting mirror 705; a circuit unit 82 for lighting the LEDs; and a base 720 electrically connected to the circuit unit 82. The circuit unit 82 is housed in a hollow portion 756a of the light-guiding member 756. The top part 762 (light-emitting portion) of the light-guiding member 756 is located at or near the focal point of the reflecting mirror 5.

### (1) Base

The base 720 is attached to one end of a projecting part 731 of the reflecting mirror 705 and to one end of the light-guiding member 756 so that the base 720 covers the opening provided in the projecting part 731 of the reflecting mirror 705. Note that the base 720 may be attached to the reflecting mirror 705 by a screw, adhesive, a latching structure or the like. In this example, the base 720 is fixed to the reflecting mirror 705 by adhesive.

The base 720 includes: a base body 783 to be that is to be attached to the reflecting mirror 705 and the light-guiding member 756; a shell 722 that is attached to the base body 783; and an eyelet 724 provided at one end of the base body 783.

The base body 783 is composed of a large-diameter cylindrical part 797 and a small-diameter cylindrical part 799 having a smaller diameter than the large-diameter cylindrical part 797. A slope 701 is provided between the large-diameter cylindrical part 797 and the small-diameter cylindrical part 799. The small-diameter cylindrical part 799 extends from the edge closer to the eyelet 724 of the large-diameter cylindrical part 797. Note that the cross section of the large-diameter cylindrical part 797 and the cross section of the small-diameter cylindrical part 799 have an annular shape. There are various types of bases, and the small-diameter cylindrical part 799 of the base 720 in this example has a shape similar to a base of an Edison type, such as the E11 type. However, this is not essential.

The base body 783 has a first concavity 704 and a second concavity 703. The first concavity 704 has a step-like shape and is concave in the direction from the large-diameter cylindrical part 797 to the small-diameter cylindrical part 799. The second concavity 703 extends deeper from the approximate center point of the first concavity 704.

The shape of the first concavity 704 (in plan view) matches the appearance of the LED module 740 (i.e. the shape of the outline in plan view). The LED module 740 fits into the first concavity 704, and thus the LED module 740 is attached to the base body 783. Note that the LED module 740 may be attached to the first concavity 703 by a screw, adhesive, a latching structure or the like. In this example, the LED module 740 is fixed to the first concavity 703 by adhesive.

The structure of the shell 722 and the eyelet 724 are the same as the shell and the eyelet of Embodiment 4, for example.

### (2) LED Module

The LED module 740 includes: a mounting board 721; a plurality of LEDs 723 mounted on the surface of the mounting board 721; and a sealer 725 covering the LEDs 723 on the mounting board 721.

The mounting board 721 is an insulative board, and has a circular shape in plan view (plan view shape). The mounting board 721 is provided with: through holes 707 and 709 through which the wiring lines connecting the base 720 and the circuit unit 82 pass; and electrode pads 715 and 717 for connecting the base 720 and the LEDs 723.

The sealer 725 primarily contains a translucent material. When it is necessary to convert the wavelength of the light emitted from the LEDs 723 to a predetermined wavelength, the translucent material may be mixed with a wavelength converting material for converting the wavelength.

A silicone resin may be used as the translucent material, and phosphor particles may be used as the wavelength converting material.

In this example, the LEDs 723 emit blue light, and phosphor particles that convert blue light to yellow light is used as the wavelength converting material. With this structure, the blue light emitted from the LEDs 723 is mixed with the yellow light whose wavelength has been converted by the phosphor particles, and consequently, the LED module 740 (LED lamp 701) emits white light. Note that the center point of the light-emitting part composed of the plurality of LEDs 723 is located in the optical axis of the reflecting mirror 705.

### (3) Light-Guiding Member

The light-guiding member 756 has the hollow portion 756a as described above, and includes the main body 741 and the leg 743. The light-guiding member 756 is attached to the reflecting mirror 705 so that the main body 741 extends from the bottom of the reflecting mirror 705.

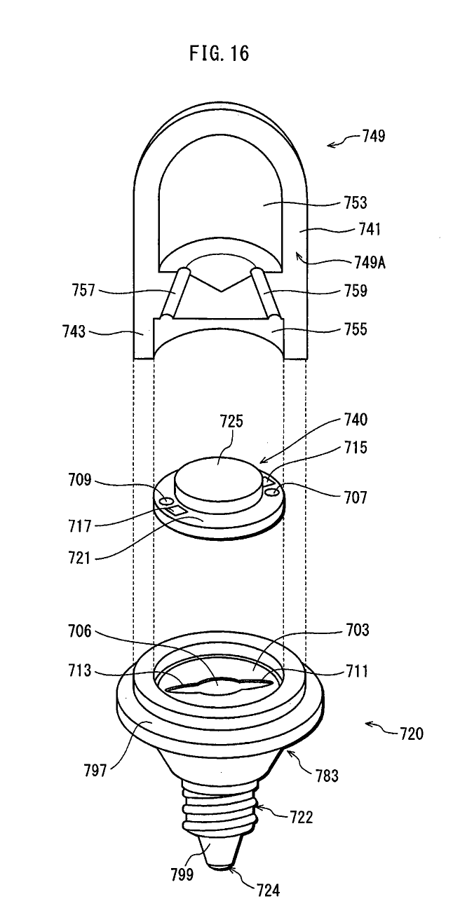

FIG. 16 is an exploded perspective view of the light-guiding member 756, the LED module 740 and the base 720.

The main body 741 has a pillar shape (columnar shape in this example) with a hollow portion 756a, and both ends are closed. A leg 743 is extended from proximal end of the main body 741 (the end closer to the base 720). The distal end (also referred to as the top part) of the main body 741 has a hemisphere shape. The leg 743 has a cylindrical shape. As shown in FIG. 15 and FIG. 16, the hollow portion 756a is a space having a shape like a cylinder combined with a hemisphere and a cone at both ends. The hemisphere end corresponds in position to the distal end.

A LED module 740 is housed in the cylindrical leg 743 so as to face the proximal end 761 (light-receiving portion) of the main body 741. A circuit unit 82 is housed in the hollow portion 756a. Communication pathways 745 and 747 are formed between the hollow portion 756a of the main body 741 and the proximal end 761 of the main body 741. The hollow portion 756a is in communication with the space within the leg 743 via the communication pathways 745 and 747. Wiring lines 788 and 789 run through the communication pathway 745 and 747, and thereby the circuit unit 82 and the LED module 740, and also the circuit unit 82 and the base 720 are electrically connected.

The light-guiding member 756 is composed of two members (i.e. a first member 749 and a second member 751) combined together, which are plane-symmetrical. The second member 751 is not shown in FIG. 15, because it is nearer than the cross section shown in FIG. 15. Similarly, FIG. 16 shows the first member 749 only, because the first member 749 and the second member 751 are separated in order to show the inside of the light-guiding member 756.

As described above, the first member 749 and the second member 751 are plane-symmetrical, and thus have the same structure. The reference signs used for describing the first member 749 is also applied to the second member 751.

Each of the first member 749 and the second member 751 is provided with a first concavity 753 near the distal end. The first concavities 753 constitute the hollow portion 756a. Also, each of the first member 749 and the second member 751 is provided with a second concavity 755 near the proximal end. The second concavities 755 constitute the cylindrical leg 743. Continuous grooves 757 and 759 used for the wiring lines 788 and 789 are formed between the first concavity 753 and the second concavity 755 in the first member 749 and the second member 751.

A fitting surface 749A of the first member 749 and a fitting surface 751A of the second member 751 are fit to each other, and thus the light-guiding member 756 having a pillar shape is formed, as described above.

When the light-guiding member 756 is attached to the reflecting mirror 705, the proximal end of the light-guiding member 756 (the circular proximal end of the main body 741) faces the light-emitting portion (the sealer 725 housing the LEDs) of the LED module 740.

Therefore, the light emitted by the LED module 740 enters the light-guiding member 756 from the proximal end of the main body 741 of the light-guiding member 756. Thus the proximal end 761 of the main body 741 serves as the light-receiving portion of the light-guiding member 756.

The top part 762, which is the distal end of the light-guiding member 756, has been processed to have light-diffusion function, by frosting for example. The light which has been travelling within the light-guiding member 756 is emitted from the distal end after being diffused. That is, the light is emitted in the all directions from the top part 762.

### (4) Circuit Unit

The circuit unit 82 is composed of a circuit board 84 and various types of electronic parts mounted on the circuit board 84, such as 86a and 86b. The circuit unit 82 is housed in the light-guiding member 756 such that the circuit board 84 is attached to the proximal end of the hollow portion 756a of the light-guiding member 756, for example. The circuit board 84 is attached to the light-guiding member 756 by adhesive.

### (5) Reflecting Minor

The entire body of the reflecting minor 705 has a funnel-like shape. The reflecting minor 705 includes a main body 729 having a conical shape which constitutes a part of the funnel-like shape, and a projecting part 731 having a cylindrical shape which constitutes the rest of the funnel-like shape. That is, the proximal end (the end farther from the base 720) of the reflecting mirror 705 has an opening, and the distal end thereof has an opening that is smaller than the opening in the proximal end, and the reflecting surface is formed on the inner surface of the funnel-like body.

Note that a through hole 737, which passes through inside the projecting part 731, is provided at the intersection of the plane extended from the surface of the main body 729 and the optical axis of the reflecting mirror 705, and the intersection and the part surrounding it is referred to as the bottom of the main body 729 or the base part of the reflecting mirror 705. Also note that the opening 733 in the main body 729 coincides with the opening 733 of the reflecting mirror 705.

The cross section of the projecting part 731 is cylindrical, for example, and is extended outward from the bottom of the main body 729. The proximal end of the light-guiding member 756 is inserted in and attached to the through hole 737 provided in the projecting part 731. Specifically, in the light-guiding member 756, the leg 743 and a part of the main body 741 near the leg 743 is inserted in the through hole 737 of the reflecting mirror 705, and is attached to the reflecting mirror 705 by adhesive which is not illustrated. A base 720 is attached to the outside end of the projecting part 731.

Note that the front panel 9 has the same structure as those used in the Embodiment 4 and so on.

### 2. Electrical Connection

(1) Electrical Connection between Circuit Unit and Base

As described above, the circuit unit 82 and the base 720 are connected via the wiring lines 790 and 791. As shown in FIG. 15, the wiring lines 790 and 791 pass through the inside of the base body 783 (the second concavity 705 and the first concavity 703), the through holes 707 and 709 of the mounting board 721 of the LED module 740 (see FIG. 16), the inside of the leg 743 of the light-guiding member 756 and the communication pathways 745 and 747 of the main body 741 of the light-guiding member 756.

As shown in FIG. 16, a portion of the first concavity 703 in the base body 783 is cut out (as indicated by the reference signs “711” and “713”). Hence the wiring lines 790 and 791 are led from the mounting board 721 of the LED module 740 to the second concavity 704.

(2) Connection between Circuit Unit and LED Module

The circuit unit 82 and the LED module 740 are connected via wiring lines 788 and 789. As shown in FIG. 15, the wiring lines 788 and 789 pass through the inside of the leg 743 of the light-guiding member 756 and the communication pathways 745 and 747 of the main body 741 of the light-guiding member 756. The wiring lines 788 and 789 are connected to the circuit unit 82 by soldering (not illustrated). Although not seen from FIG. 15 and FIG. 16, the wiring lines 788 and 789 pass through the communication pathways 745 and 747 together with the wiring lines 790 and 791. The base 720 and the LEDs 723 are connected via the electrode pads 715 and 717.

The wiring lines 788 and 789 are connected to the LED module 740 and the circuit unit 82 by soldering (not illustrated).

### 3. Heat Radiation Path

In the LED lamp 701 pertaining to this embodiment as with Embodiment 4 and so on, the heat generated by the LEDs 723 during the operation is conducted to the base 720, and is further conducted from the base 720 to the body of the lighting fixture, the wall and the ceiling via the socket.

### 4. Optical Path

With the stated structure, the LED module 740 is located within the space surrounded by the base body 783 of the base 720, the leg 743 of the light-guiding member 756 and the proximal end 761 of the main body 741 of the light-guiding member 756. Hence the light-emitting surfaces of the LEDs 723 of the LED module 740 (i.e. the surface of the sealer 725) face the proximal end of the main body 741 of the light-guiding member 756. That is, the proximal end 761 of the main body 741 of the light-guiding member 756 coincides with the light-receiving portion where the light emitted from the LED module 740 enters.

That is, the light emitted from the LED module 740 enters from the proximal end 761 of the light-guiding member 756. After that, the light travels within the light-guiding member 756 while being repeatedly reflected off the boundary surface between the light-guiding member 756 and the air layer (i.e. the outer circumferential surface of the light-guiding member 756) and between the outer circumferential surface of the light-guiding member 756 and the inner circumferential surface forming the hollow portion 756a. Then, when the incident angle with respect to the outer circumferential surface is equal to or smaller than the critical angle, a portion of light is emitted outside the light-guiding member 756 according to the incident angle.

Hence, a portion of the light travelling within the light-guiding member 756 passes by the circuit unit 82 housed in the hollow portion 756a, and is emitted from the top part 762 of the distal end that is opposite to the proximal end 761.

In the light-guiding member 756, it is preferable that the position where the hollow portion 756a is located in the central axis direction of the light-guiding member 756 is closer to the top part 762 than to the proximal end 761 as with the example shown in FIG. 15. This is because such a structure allows the circuit unit 82 to be distant from the LED module 740, and to be less affected by heat during the operation.

The top part 762 (light-emitting portion) of the light-guiding member 756 is located at the focal point of the reflecting mirror 705. That is, the center point of the hemisphere of the top part of the light-guiding member 756 coincides with the focal point of the reflecting mirror 705 in design.

Hence a portion of the light emitted from the top part 762 of the light-guiding member 756, that is emitted toward the opening 733 in the reflecting mirror 705 (toward the front panel 9), passes through the front panel 9, and is then output from the LED lamp 701. On the other hand, another portion of the light, which is emitted toward the reflecting surface 735 of the reflecting mirror 705, is reflected off the reflecting surface 735 toward the front panel 9, and passes through the front panel 9, and is then output from the LED lamp 701.

### 5. Effects

With this structure, since the hollow portion 756a is located opposite to the base 720 with respect to the LED module 740, it is unnecessary to locate the circuit unit 82 within the space between the LED module 740 and the base 720. Hence the distance between the LED module 740 and the base 720 can be reduced, and the amount of heat conducted from the LED module 740 to the base 720 can be increased.

Also, since the circuit unit 82 is located within the reflecting mirror 705, there is no need to leave a space between the LED module 740 and the base 720 for disposing the circuit unit 82. This reduces in size the distal end part of the reflecting mirror 705, the base body 783 of the base 720, and so on. Due to the size reduction, there is a possibility of temperature rise in the base 720 on which the LED module 740 is mounted. However, since the circuit unit 82 is not located between the LED module 740 and the base 720, the circuit unit 82 is less affected by heat.

Moreover, since the LED module 740 is located close to the base 720, the interval between the LED module 740 and the top of the reflecting mirror 705 (i.e. the top part shown in FIG. 9) is increased, and there is an enough space for housing the circuit unit 82.

### Embodiment 10

The following describes Embodiment 10, in which the light emitted by the LED module is blue light. Note that same reference signs are applied to the same elements as in Embodiments 1-9 described above.

### 1. Structure

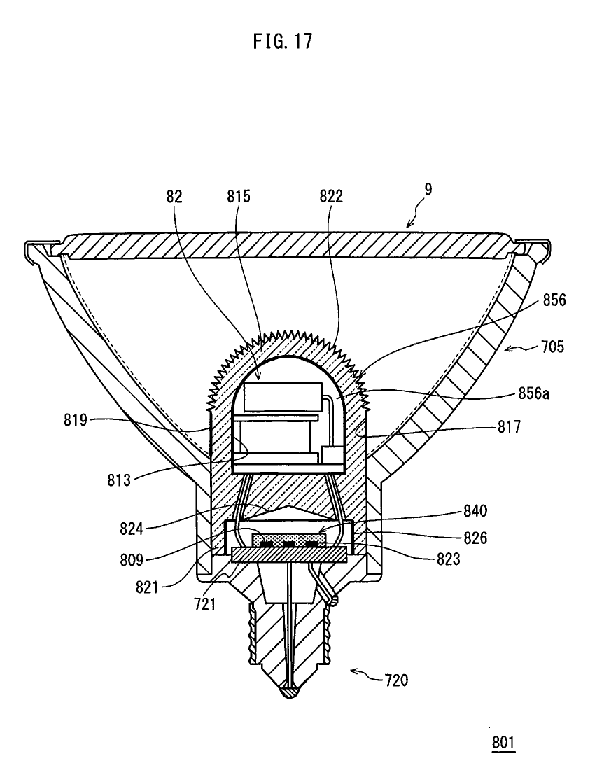

FIG. 17 is a cross-sectional view showing the structure of an LED lamp 801 pertaining to Embodiment 10.

The LED lamp 801 pertaining to Embodiment 10 includes an LED module 840, a reflecting mirror 705, a light-guiding member 856, a front panel 9, a circuit unit 82 and a base 720.

The LED module 840 is composed of a mounting board 721, LEDs 823, and a sealer 809. The LEDs 823 emit blue light, but the sealer 809 does not contain a wavelength converting material. That is, the sealer 809 is made of a translucent material, and the LED module 840 emits blue light. The LED module 840 is attached to the base 720 in the same manner as Embodiment 9.

The light-guiding member 856 basically has the same structure as the light-guiding member 756 of Embodiment 9, except that a reflecting film 813 is formed on the internal surface forming the hollow portion 856a, and that a reflecting film 819 is formed on a portion of the circumferential surface 817 of the light-guiding member 856 where is exposed to the inside space of the reflecting mirror 705 and does not include the hemisphere part (815) located at the top. Serriform concavities and convexities are formed on the surface of the light-emitting part 815.

A phosphor layer 822 is formed on the surface of the light-emitting part 815 of the light-guiding member 856. The phosphor layer 822 is composed of a wavelength converting member (phosphor particles in this example) that converts light (blue light in this example) emitted from the LED module 840 to light of a predetermined color (yellow light in this example).

A reflecting film 826 is formed on the inner circumferential surface of the leg 821 of the light-guiding member 856 (except the proximal end 824). The reflecting film 826 reflects the light emitted from the LED module 840 toward the proximal end 824 of the light-guiding member 856. Thus the proximal end 824 of the light-guiding member 856 serves as the light-receiving portion.

Note that although the phosphor layer 822, which converts blue light emitted from the LED module 840 to yellow light, is formed on the light-emitting part 815 of the light-guiding member 856, the phosphor layer 822 may be formed on the proximal end 824 of the light-guiding member 856 or on the back side of the front panel 9. Also, the material of the front panel, such as a resin material or a ceramic material, may be mixed with a wavelength converting material.

### 2. Effects

With the stated structure, the blue light emitted from the LED module 840 enters the light-guiding member 856, and when emitted from the light-emitting part 815, a portion of the blue light is converted to yellow light. The blue light directly emitted from the light-guiding member 856 and the yellow light resulting from the wavelength conversion by the phosphor layer 822 are mixed. Consequently, the LED lamp 801 outputs white light.

Moreover, since the reflecting films 813 and 819 are formed, the light traveling within the light-guiding member 856 toward the light-emitting part 815 as the top part of the hemisphere is prevented from being emitted to the hollow portion 856a or to the outside.

Furthermore, since serriform concavities and convexities are formed on the surface of the light-emitting part 815, the light-guiding member 856 emits wider light than Embodiment 9.

### Embodiment 11

In Embodiments 9 and 10, the front panel 9 is attached to the reflecting mirror. However, when the light emitted from the light-emitting part of the light-guiding member is of a desired color, the lamp may be an open lamp without a front panel.

Moreover, the shape of the light-guiding member is not limited to the shape described in Embodiments 9 and 10, and another shape may be adopted.

The following describes Embodiment 11, which is an open LED lamp with a light-guiding member having a different shape than Embodiments 9 and 10. Note that same reference signs are applied to the same elements as in Embodiments 9 and 10 described above.

### 1 Overall Structure

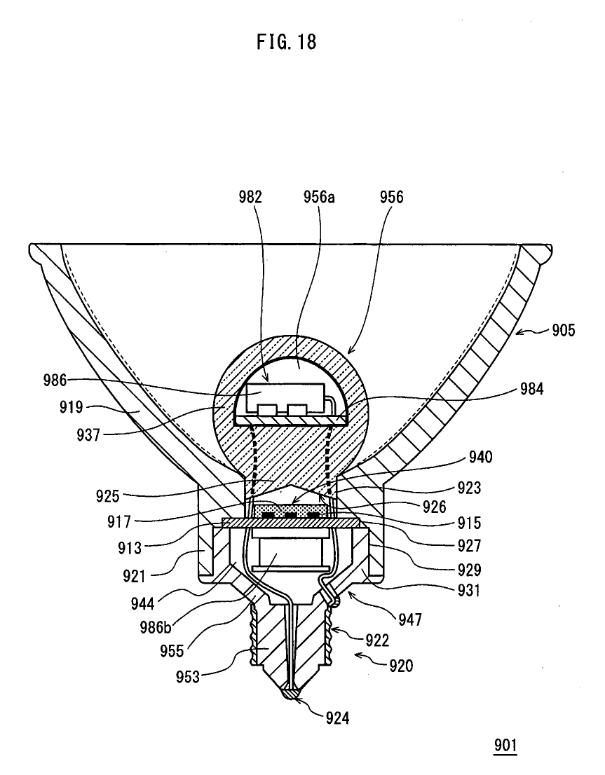

FIG. 18 is a cross-sectional view showing the structure of an LED lamp 901 pertaining to Embodiment 11.

The LED lamp 901 pertaining to Embodiment 11 includes an LED module 940, a reflecting mirror 905, a light-guiding member 956, a circuit unit 982 and a base 920.

The LED module 940 is composed of a mounting board 913, a plurality of LEDs 915, and a sealer 917. Note that the LEDs 915 emit blue light as with Embodiment 9, and the sealer 917 contains phosphor particles for yellow light.

The internal surface of the reflecting mirror 905 is a concave reflecting surface, and the entire body thereof is in the funnel-like shape. The reflecting mirror 905 includes a main body 919 and a cylindrical projecting part 921 as with Embodiment 9. The projecting part 921 is provided with a through hole.

The through hole increases its diameter stepwise (three steps in this example) from the end closer to the main body 919 to the end closer to the base 920. Note that although the cross section of the through hole in this example is circular, another shape, such as polygonal shape, may be adopted.

The through hole includes: a first hole part 923 located near the main body 919, in which the supporter 925 of the light-guiding member 956 and a portion of the sealer 917 of the LED module 940 are disposed; a second hole part 927 next to the first hole part 923 and having a larger diameter than the first hole part 923, in which the mounting board 913 of the LED module 940 is disposed; and a third hole part 929 located near the base 920 and next to the second hole part 927, in which the large-diameter cylindrical part 931 of the base 920 is inserted.

The length of the second hole part 927 in the central axis direction corresponds to the thickness of the mounting board 913 of the LED module 940. While the mounting board 913 is engaging with the second hole part 927 and the large-diameter cylindrical part 931 of the base 920 is being inserted in the third hole part 929, the base 920 is attached to the reflecting mirror 905, and thus the LED module 940 is positioned and fixed (attached).

The base 920 includes a base body 947, a shell 922 and an eyelet 924. The base body 947 includes: a large-diameter cylindrical part 931 inserted in the first hole part 929 of the projecting part 921 of the reflecting mirror 905; a small-diameter cylindrical part 953 in which the shell 922 and the eyelet 924 are provided; and a slope 955 provided between the large-diameter cylindrical part 931 and the small-diameter cylindrical part 953.

### 2 Light-Guiding Member

As described above, the light-guiding member 956 includes: the supporter 925 a portion of which is inserted in the first hole part 923 of the reflecting mirror 905; and a bulging part 937 bulging from the proximal end (i.e. the end farther from the base 920) of the supporter 925. A portion of the circuit unit 982 is housed in the hollow portion 956a of the bulging part 937.

The supporter 925 has a circular cross section, which corresponds in shape to the cross section of the first hole part 923 of the reflecting mirror 905. That is, the supporter 925 has a columnar shape. The supporter 925 reaches approximately the middle point of the first hole part 923 in the central axis direction. The sealer 917 of the LED module 940 is housed in the rest of the first hole part 923. Thus the proximal end 926 of the light-guiding member 925 serves as the light-receiving portion.

The bulging part 937 bulges from the part of the reflecting mirror 905 corresponding to the bottom of the main body 919 in the direction perpendicular to the optical axis of the reflecting mirror 905 (i.e. toward the opening) to form a sphere-like shape. The center point of the bulging part 937 having a sphere-like shape coincides with the focal point of the reflecting mirror 905 in design.

The bulging part 937 has been processed to have light-diffusion function. In this example, light-diffusive particles are mixed in the bulging part 937 of the light-guiding member 956. These light-diffusive particles change the travelling direction of the light within the bulging part 937, and thus the light is emitted from the bulging part 937 ununiformly. Thus, the bulging part 937 serves as the light-emitting part.

Consequently, the light emitted from the bulging part 937 of the light-guiding member 956 to the area that is closer to the base 920 than to the focal point is led toward the reflecting surface. Therefore, when the reflecting surface 905 is paraboloidal as with Embodiment 4, the light output from the reflecting mirror 905 will be parallel. When the reflecting surface 905 is ellipsoidal, the light will be concentrated.

When a pillar 335 is inserted into the first hole part 923 the bulging part 937, the bulging part 937 comes in contact with the main body 919 of the reflecting mirror 905, and thus the insertion of the pillar 335 is regulated.

The hollow portion 956a provided within the light-guiding member 956 has a hemisphere shape corresponding to the outline of the sphere-like bulging part 937. The circuit board 984 of the circuit unit 982 is attached to the flat part of the hollow portion 956a near the proximal end. Some of electronic parts constituting the circuit unit 982, such as the electronic part 986, are mounted on the circuit board 984.

The heatproof temperature of the electronic parts 986 and so on is lower than the temperature of and around the LED module 940 during the operation. One example of such electronic parts is an electrolytic capacitor.

In Embodiment 10, the electronic part 986 having a low heatproof temperature among the electronic parts constituting the circuit unit 982 is housed within the hollow portion 956a of the light-guiding member 956, and an electronic part 986b having a high heatproof temperature is housed within the space 944 in the large-diameter cylindrical part 931 of the base 920. One example of the 986b having a high heatproof temperature is a choke coil. In this example, the electronic part 986b is mounted on the back surface (i.e. one of the main surfaces that is closer to the base 920) of the mounting board 913 of the LED module 940.

### 3. Effects

With the stated structure, the electronic parts 986 and 986b can be separately housed within the lamp even when a large number of electronic parts are used in the circuit unit for dimming or the size of the light-guiding member is small and not all the electronic parts constituting the circuit unit can be housed in the hollow portion.

### Embodiment 12

In Embodiments 9 through 11, no anti-heat measure is taken for the circuit units 82 and 982. However, it is possible to take an anti-heat measure. The following describes Embodiment 12 in which an anti-heat measure is adopted in circuit units 82 and 982.

Note that the following description is based on the LED lamp 701 described as for Embodiment 9, and same reference signs are applied to the same elements as in Embodiment 9.

### 1. Structure

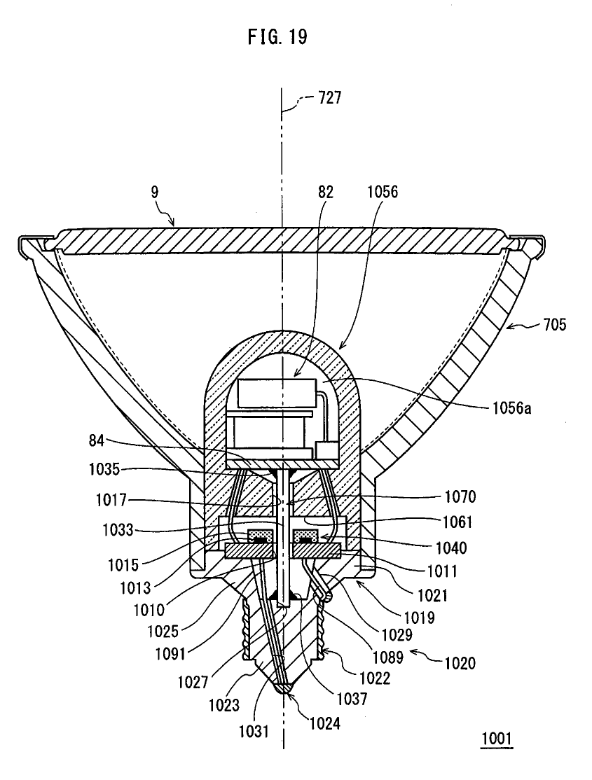

FIG. 19 is a cross-sectional view showing the structure of an LED lamp 1001 pertaining to Embodiment 12.

The LED lamp 1001 pertaining to Embodiment 12 includes: an LED module 1040; a reflecting mirror 705 housing the LED module 1040; a light-guiding member 1056 for guiding light emitted from the LED module 1040 to the area including or near the focal point of the reflecting mirror 705; a front panel 9 provided on the side of the reflecting mirror 705 closer to the opening; a circuit unit 82 for lighting the LEDs; a base 1020 electrically connected to the circuit unit 82; and a conductive member 1070 for conducting heat generated by the circuit unit 82 to the base 1020.

The LED module 1040 includes: a mounting board 1011 having an annular shape provided with a through holes 1010 in the center thereof; a plurality of LEDs 1013 mounted on the mounting board 1011; and a sealer 1015 covering the LEDs 1013. Note that the LEDs 1013 are arranged at equal intervals along the circumferential direction of the mounting board 1011, for example.

The light-guiding member 1056 is different from the light-guiding member 756 of Embodiment 9 in that the light-guiding member 1056 is provided with a through hole 1017 with which a hollow portion 1056a for housing the circuit unit 82 is in communication with a light-receiving surface 1061 (i.e. the external surface near the light-emitting portion). The through hole 1017, and the through hole 1010 of the mounting board 1011 are formed along the optical axis 727 (which coincides with the central axis of the LED lamp 1001, the reflecting mirror 705, the light-guiding member 1056 and the base 1020), and the conductive member 1070 is located within this space.

The base 1020 includes a base body 1019, a shell 1022 and an eyelet 1024 as with Embodiment 9. The base body 1019 includes a large-diameter cylindrical part 1021, a small-diameter part 1023, and a slope 1025. The LED module 1040 is mounted on the end surface of the large-diameter cylindrical part 1021 that is farther from the small-diameter part 1023.

The small-diameter part 1023 has a concavity 1027 provided in the end surface closer to the large-diameter cylindrical part 1021, through which the optical axis 727 passes. In addition, the small-diameter part 1023 is provided with through holes 1029 and 1031 for the wiring lines 1090 and 1091 connecting the base 1020 and the circuit unit 82.

The conductive member 1070 is a highly heat-conductive material, such as a metal material, and includes a bar-like member 1033. One end of the bar-like member 1033 is inserted in the concavity 1027 of the small-diameter part 1023 of the base 1020 and is fixed by adhesive 1037, and the other end is fixed so as to be in contact with the circuit board 84 of the circuit unit 82 by adhesive 1035.

### 2. Effects

With the stated structure, the heat accumulated in the circuit unit 82 is conducted from the bar-like member 1033 as the conductive member 1070 to the base 1020, and thus the temperature rise in the circuit unit 82 is prevented.

### Modifications

The structure of the present invention has been described above based on Embodiments 1 through 12. The present invention, however, is not limited to the embodiments above. For example, the following modifications may be adopted.

### 1 Base

Although the Edison-type base is used in the embodiments above, another type such as a pin-type (specifically, G-type such as GY and GX) may be used.

Also, although the base of the embodiments is hollow, the inside of the base may be filled with an insulative material that has a higher conductivity than the air. With such a structure, the head generated by the LED module during the operation is conducted to the lighting fixture via the base and the socket. This improves the total heat radiation rate of the lamp. One example of the insulative material is a silicone resin.

### 2 LED Module

### (1) Mounting Board

Existing mounting boards, such as a resin board, a ceramic board, a metal-based board composed of a resin plate and a metal plate, or the like may be used as the mounting board.

### (2) LED

In the embodiments above, LEDs emitting blue light and a converting member converting blue light to yellow light are used. However, LEDs that emit light of another color may be used. If this is the case, it is necessary to use a wavelength converting material that converts the color of light to the desired color for the LED lamp.

Also, although the embodiments above utilize LEDs of a single type so that the LED module (the LED lamp) emits white light, three types of LEDs, namely LEDs emitting blue light, red light and green light may be used, and these colors of light may be mixed to obtain white light. Moreover, near-ultraviolet LEDs may be used in combination with a phosphor formed from the mixture of a red phosphor, a blue phosphor and a green phosphor. Note that the LED module may be composed of a plurality of SMDs (Surface Mount Devices).

Furthermore, the number of LEDs is not limited to the number adopted for the embodiments above, and may be changed according to the required brightness, for example.

### (3) Sealer

In Embodiments 9 through 12, the sealer covers all the LEDs mounted on the mounting board. However, a single LED may be covered with a single sealer, or the LEDs may be grouped and a predetermined number of LEDs may be covered with a single sealer.

Moreover, although phosphor particles are contained in the translucent material used in Embodiments 9 through 12, a phosphor layer containing phosphor particles may be formed on the translucent material. Furthermore, a wavelength converting member such as phosphor plate which contains phosphor particles may be disposed at the location where the light emitted from the LEDs reaches, in addition to the sealer (the LED module).

### (4) Arrangement of LEDs on Mounting Board

In embodiments above, the LEDs are arranged annularly. However, the arrangement is not limited to this. For example, the LEDs may be arranged in an ellipsoidal pattern, a square pattern, or a polygonal pattern, for example.

### 3. Wavelength Conversion

In Embodiments 9 through 12, the phosphor particles for converting the wavelength of the light emitted from the LEDs are included in the sealer or the phosphor layer containing the phosphor particles are formed on the light-emitting part of the light-guiding member. However, the phosphor layer may be formed on the back surface of the front panel of Embodiment 8 or 9, or on the light-receiving surface from which the light emitted from the LED module enters the light-guiding member.

Furthermore, a wavelength converting plate or the like including a wavelength converting material may be disposed between the light-receiving surface of the light-guiding member and the LED module.

### 4 Light-Guiding Member

### (1) Overall Structure

The shape of the light-guiding member may be selected from among a tubular shape with an ellipsoidal cross section, a tubular shape with a rectangular cross section or a tubular shape with a polygonal cross section, according to the arrangement of the LEDs on the mounting board. That is, in order to allow the light emitted from the LEDs arranged as described above to enter the proximal end of the light-guiding member having a tubular shape, the shape of the light-guiding member (i.e. the shape of the proximal end) is determined to match the arrangement of the LEDs. Note that the light-guiding member may be deposed to stand on the surface of the seating member, the seating, the base, and so on.

### (2) Top Part of Light-Guiding Member

In embodiments above, the light-guiding member having a spherical or semispherical top part is adopted. However, this is not essential. The top part of the light-guiding member may have the shape of a truncated tetrahedron, a truncated hexahedron, a truncated octahedron, a truncated dodecahedron, a truncated icosahedron, a rhombicuboctahedron, a rhombicosidodecahedron, a rhombitruncated cuboctahedron, a rhombitruncated icosidodecahedron, or a semi-regular polyhedron other than a rhombicubooctahedron, such as a snub cube or a snub dodecahedron.

Alternatively, the light-guiding member may have the shape of a regular polyhedron, such as a regular tetrahedron, a regular hexahedron, a regular octahedron, a regular dodecahedron or a regular icosahedron. Instead of a regular polyhedron, a semiregular polyhedron may be adopted, such as a cuboctahedron, an icosidiodecaherdon, a dodecadodecahedron, a great icosidodecahedron, a small ditrigonal icosidodecahedron, a ditrigonal dodecadodecahedron, a great ditrigonal icosidodecahedron, a tetrahemihexahedron, an octahemioctahedron, a cubohemioctahedron, or a small icosihemidodecahedron.

Alternatively, the light-guiding member may have the shape of a regular star polyhedron such as a small stellated dodecahedron, a great dodecahedron, a great stellated dodecahedron, or a great icosahedron. The top part of the light-guiding member may have the shape of a uniform polyhedron, such as a small cubicuboctahedron, a great cubicuboctahedron, a cubitruncated cuboctahedron, a uniform great rhombicuboctahedron, a small rhombihexahedron, a great truncated cuboctahedron, a great rhombihexahedron, a small icosicosidodecahedron, a small snub icosicosidodecahedron, a small dodecicosidodecahedron, a truncated great dodecahedron, a rhombidodecadodecahedron, a truncated great icosahedron, a small stellated truncated dodecahedron, a great stellated truncated dodecahedron, a great dirhombicosidodecahedron, or a great disnub dirhombidodecahedron.

Alternatively, the top part may have the shape of an Archimedean dual, a deltahedron, a Johnson solid, a stellation, a zonohedron, a parallelohedron, a rhombohedron, a polyhedral compound, a compound, a perforated polyhedron, Leonardo da Vinci's polyhedra, a ring of regular tetrahedra, and a regular skew polyhedron.

### 5 Circuit Unit

In the Embodiments 9 through 12, the circuit board of the circuit unit is positioned such that the main surface of the circuit board is orthogonal to the lamp axis. However, the circuit board may be positioned such that the main surface is parallel with the lamp axis, or is slanted with respect to the lamp axis.

Although the arrangement of the electronic parts mounted on the circuit board is not mentioned in Embodiments 9 through 12, electronic parts of a large size (volume, height, etc.) may be arranged in the center of the circuit board, and electronic parts of a small size may be arranged around them. This leads to an effective use of the space within the light-guiding member, and consequently, the light-guiding member can be reduced in size.

Furthermore, the circuit unit may be divided in two by grouping the electronic parts constituting the circuit unit into parts having relatively high heat resistance and parts having relatively low heat resistance. If this is the case, one of the circuit units composed of the parts having relatively low heat resistance is housed in the hollow portion as with the embodiments above, and the one of the circuit units composed of the parts having relatively high heat resistance is housed in the base. Such a structure leads to the reduction in size of the light-guiding member, which leads to the reduction in size of the lamp as a whole.

In embodiments above, the circuit unit is housed in the hollow portion without a covering. The circuit unit, however, may be housed in a case (circuit case), and then housed in the hollow portion.

When a tall electronic part is included in the electronic parts of the circuit unit of the lamp having a reflecting mirror, it is preferable that the tall part may be mounted near the center of the annular circuit board (i.e. close to the inner circumference of the circuit board). With such a structure, the circuit unit can be located close to the base part of the reflecting mirror. As the circuit unit is located closer to the base part of the reflecting minor, a smaller portion of the light, which travels from the light-emitting part of the light-guiding member toward the reflecting surface of the reflecting minor, is blocked by the circuit unit. Hence, such a structure more effectively utilizes the reflecting minor to obtain a preferable light-distribution characteristic.

### 6 Conductive Member

It is preferable that the conductive member is made of a material having high heat conductivity. The shape of the conductive member may be a tubular shape with an ellipsoidal cross section, a tubular shape with a rectangular cross section or a tubular shape with a polygonal cross section. Also, it is preferable that the conductive member is insulative so that no current flows between the circuit unit and the base via the conductive member.

### INDUSTRIAL APPLICABILITY

The present invention is applicable for the reduction in size and the improvement in brightness of lamps.

### REFERENCE SIGNS LIST

10, 102, 130, 160 LED Lamp
20, 166 Base
44, 46, 48, 50, 52, 54, 106, 114, 120 LED
56, 108, 132, 176 Light-guiding member
82, 190 Circuit Unit
96, 170 Globe
100 Envelope

1. A lamp comprising:
an envelope including a base and a globe;
one or more semiconductor light-emitting elements;
a circuit unit lighting the semiconductor light-emitting elements; and
a light-guiding member having a hollow portion, a light-entering portion, and a light-emitting portion connected to the light-entering portion,
the semiconductor light-emitting elements, the circuit unit and the light-guiding member being housed in the envelope, wherein
the light-entering portion is held within the envelope so as to face the semiconductor light-emitting elements, and
at least part of the circuit unit is located within the hollow portion of the light-guiding member.

2. The lamp of claim 1, wherein
the light-guiding member has a tubular shape and is located within the globe such that the light-entering portion faces the base, and
the semiconductor light-emitting elements are arranged in a circumferential direction of the light-entering portion such that light-emitting surfaces of the semiconductor light-emitting elements face the light-receiving portion.

3. The lamp of claim 2 further comprising:
a mounting board having an annular shape and mounted with the semiconductor light-emitting elements arranged in a circumferential direction of the mounting board at intervals;
a seating mounted with the mounting board; and
a heat-conducting member connecting the seating to the base.

4. The lamp of claim 3, wherein
the seating has a plate-like shape,
the heat-conducting member has a tapered tubular shape, and
the seating is attached to a large-diameter end of the heat-conducting member, and the base is attached to a small-diameter end of the heat-conducting member.

5. The lamp of claim 2, wherein
a reflecting film is formed on an internal surface of the light-guiding member.

6. The lamp of claim 2, wherein
a wavelength converting layer is formed on an external surface of the light-guiding member, the wavelength converting layer converting light emitted by the semiconductor light-emitting elements to light having a different wavelength.

7. The lamp of claim 2, wherein
a wavelength converting layer is formed on an internal surface of the globe, the wavelength converting layer converting light emitted by the semiconductor light-emitting elements to light having a different wavelength.

8. The lamp of claim 1, wherein
the envelope has an open end and includes a reflecting mirror having a reflective internal surface,
the base is attached to the other end of the envelope, and
the light-emitting portion of the light-guiding member is located at or close to a focal point of the reflecting mirror.

9. The lamp of claim 8, wherein
the semiconductor light-emitting elements are arranged annularly around a central axis of the reflecting mirror such that the semiconductor light-emitting elements emit light in a direction away from the base, and
the light-guiding member has a tubular shape.

10. The lamp of claim 9, wherein
the light-guiding member has a tubular shape with a bottom, and the light-emitting portion has a dome-like shape.

11. The lamp of claim 9, wherein
the light-emitting portion of the light-guiding member diffuses light travelling within the light-guiding member and outputs diffused light.

12. The lamp of claim 9, wherein
a reflecting film is formed on an internal surface of the light-guiding member.

13. The lamp of claim 9, wherein
part of the circuit unit is located within the light-guiding member, and the remaining part of the circuit unit is located between the base and the semiconductor light-emitting elements.

14. The lamp of claim 8, wherein
the light-guiding member has a pillar-like shape, and has the hollow portion.

15. The lamp of claim 14, wherein
a central axis of the light-guiding member coincides with an optical axis of the reflecting mirror.

16. The lamp of claim 14, wherein
the hollow portion is located closer to the light-emitting portion of the light-guiding member than to the light-receiving portion of the light-guiding member.

17. The lamp of claim 14, wherein
the light-emitting portion of the light-guiding member diffuses light traveling within the light-guiding member and outputs diffused light.

18. The lamp of claim 14, wherein
a reflecting film is formed on an internal surface of the light-guiding member.
